(19) United States
(12) Patent Application Publication
(10) Pub. No.: US 2020/0074486 A1
(43) Pub. Date: Mar. 5, 2020

(54) INFORMATION PROCESSING SYSTEM, INFORMATION PROCESSING DEVICE, PREDICTION MODEL EXTRACTION METHOD, AND PREDICTION MODEL EXTRACTION PROGRAM

(71) Applicant: NEC Corporation, Tokyo (JP)

(72) Inventors: Yousuke MOTOHASHI, Tokyo (JP); Hiroki NAKATANI, Tokyo (JP); Akira IMAMURA, Tokyo (JP)

(73) Assignee: NEC Corporation, Tokyo (JP)

(21) Appl. No.: 16/610,979

(22) PCT Filed: May 9, 2017
(86) PCT No.: PCT/JP2017/017548

§ 371 Date: Nov. 5, 2019

(51) Int. Cl. G06Q 30/02; G06N 5/04

(52) U.S. Cl. CPC G06Q 30/0202; G06N 5/04

(57) ABSTRACT

An information processing system 80 includes a storage unit 81 which stores a plurality of prediction models that are each identified by a plurality of classifications and used for predicting a value of a prediction target, a reception unit 82 which receives at least one of the plurality of classifications, and an extraction unit 83 which extracts a prediction model from the storage unit 81 based on the classification received by the reception unit 82.

### TECHNICAL FIELD

The present invention relates to an information processing system, an information processing device, a prediction model extraction method, and a prediction model extraction program used for analyzing a factor that possibly contributes to a prediction target.

### BACKGROUND ART

Methods for conducting various analyses based on a large volume of result data are known. Point of sale (POS) data is an example of data representing a sales result at each store. For example, in a case where a company with 1000 retail stores nationwide tallies sales volumes of 2000 types of items per store on a monthly basis, the number of pieces of POS data becomes 1000 (stores)*12 (months per year)*2000 (types per month and store)=24000000 per year.

Examples of a method for analyzing such POS data include a method using a tallying tool having a capability similar to a pivot table of EXCEL (registered trademark). A user can tally a sales volume of items from various perspectives such as for each store, each season, and each item by loading the POS data into such a tallying tool, which in turn makes it possible to freely analyze factors contributing to the sales from a micro perspective to a macro perspective.

In addition, Tableau (registered trademark), SAS (registered trademark), SPSS (registered trademark), and the like are known as examples of software specialized for such statistics.

Patent Literature 1 discloses a sales analysis system capable of analyzing the root cause of poor sales by comparing a store where a target item sells badly and a store where the target item sells well using surveillance cameras, a multifunction peripheral, and the like installed in the stores

Patent Literature 2 discloses a technique of identifying an influence, on an index “sales” being a problem-solving target, of an index identifying each of business operation indexes such as the procurement, allocation, marketing, defective condition, production, and distribution.

Patent Literature 3 discloses a sales volume calculation equation generation process of generating a sales volume calculation equation used for calculating a sales volume prediction for each store and item classification and a transfer-instructing sales volume calculation process of calculating a future sales volume prediction value based on individual categorical causal track records and individual categorical causal schedule for each store and item. In these processes, past sales result data accumulated in sales database, past causal track record data accumulated in causal database such as whether a special sales is conducted, weather, temperature, whether an even is conducted, and whether flyers are distributed that affects sales. Patent Literature 3 further discloses the use of the future sales volume prediction for transfer of items between stores.

### CITATION LIST

### Patent Literature

PTL 1: Japanese Patent Application Laid-Open No. 2007-179199

PTL 2: Japanese Patent Application Laid-Open No. 2011-008375

PTL 3: Japanese Patent Application Laid-Open No. 2014-026483

### SUMMARY OF INVENTION

### Technical Problem

None of the above-described Patent Literature describes the use of a prediction model for the purpose of factor analysis. Furthermore, none of the above-described Patent Literature discloses a possibility that, when a large number of prediction models are present, the factor analysis can be conducted using these prediction models with high usability.

It is therefore and object of the present invention to provides an information processing system, an information processing device, a prediction model extraction method, and a prediction model extraction program capable of conducting, even when a large number of prediction models are present that are used for the purpose of factor analysis, the factor analysis using these prediction models with high usability.

### Solution to Problem

An information processing system according to the present invention includes, a storage unit which stores a plurality of prediction models that are each identified by a plurality of classifications and used for predicting a value of a prediction target, a reception unit which receives at least one of the plurality of classifications, and an extraction unit which extracts a prediction model from the storage unit based on the classification received by the reception unit.

An information processing device according to the present invention includes a reception unit which receives at least one of a plurality of classifications, and an extraction unit which extracts, from a storage unit that stores a plurality of prediction models that are each identified by the plurality of classifications and used for predicting a value of a prediction target, the prediction model based on the classification received by the reception unit.

A prediction model extraction method according to the present invention includes receiving at least one of a plurality of classifications, and extracting, from a storage unit that stores a plurality of prediction models that are each identified by the plurality of classifications and used for predicting a value of a prediction target, the prediction model based on the classification thus received.

A prediction model extraction program according to the present invention causes a computer to execute reception processing of receiving at least one of a plurality of classifications, and extraction processing of extracting, from a storage unit that stores a plurality of prediction models that are each identified by the plurality of classifications and used for predicting a value of a prediction target, the prediction model based on the classification received in the reception processing.

### Advantageous Effects of Invention

According to the present invention, even when a large number of prediction models are present that are used for the purpose of factor analysis, it is possible to conduct the factor analysis using these prediction models with high usability.

### BRIEF DESCRIPTION OF DRAWINGS

FIG. 1 It depicts an explanatory diagram illustrating an example of a prediction model.

FIG. 2 It depicts a block diagram of an information processing system according to the present invention, illustrating an example of a configuration of a first exemplary embodiment.

FIG. 3 It depicts an explanatory diagram illustrating an example of how to store a prediction target and a plurality of classifications with the prediction target and the classifications associated with each other.

FIG. 4 It depicts is an explanatory diagram illustrating examples of explanatory variables.

FIG. 5 It depicts is an explanatory diagram illustrating examples of prediction models.

FIG. 6 It depicts an explanatory diagram illustrating specific examples of measured values of an explanatory variable.

FIG. 7 It depicts an explanatory diagram illustrating an example of processing of extracting a prediction model based on a received classification.

FIG. 8 It depicts an explanatory diagram illustrating an example of how to display an extracted prediction model.

FIG. 9 It depicts an explanatory diagram illustrating an example where weights of prediction models are graphed.

FIG. 10 It depicts a flowchart illustrating an example of an operation of the information processing system of the first exemplary embodiment.

FIG. 11 It depicts an explanatory diagram illustrating an example of an extracted prediction model.

FIG. 12 It depicts an explanatory diagram illustrating another example of the extracted prediction model.

FIG. 13 It depicts an explanatory diagram illustrating examples of factors in a plurality of prediction models.

FIG. 14 It depicts a block diagram of the information processing system according to the present invention, illustrating an example of a configuration of a second exemplary embodiment.

FIG. 15 It depicts an explanatory diagram illustrating examples of explanatory variables to which categories are assigned.

FIG. 16 It depicts an explanatory diagram illustrating an example of processing of grouping weights for each category.

FIG. 17 It depicts a flowchart illustrating an example of an operation of the information processing system of the second exemplary embodiment.

FIG. 18 It depicts a block diagram of the information processing system according to the present invention, illustrating an example of a configuration of a third exemplary embodiment.

FIG. 19 It depicts an explanatory diagram illustrating an example of processing of calculating a degree of contribution.

FIG. 20 It depicts a flowchart illustrating an example of an operation of the information processing system of the third exemplary embodiment.

FIG. 21 It depicts an explanatory diagram illustrating an example of a screen in an initial state to be displayed on a display device.

FIG. 22 It depicts an explanatory diagram illustrating an example of information included in a drop-down list.

FIG. 23 It depicts an explanatory diagram illustrating an example of an extraction result based on a designated classification.

FIG. 24 It depicts an explanatory diagram illustrating an example of an extraction result based on a designated classification.

FIG. 25 It depicts an explanatory diagram illustrating an example where extraction results based on a designated classification are grouped for each category.

FIG. 26 It depicts an explanatory diagram illustrating an example where extraction results based on a designated classification are grouped for each category.

FIG. 27 It depicts an explanatory diagram illustrating another example where extraction results based on a designated classification are grouped for each category.

FIG. 28 It depicts an explanatory diagram illustrating an example of a sample.

FIG. 29 It depicts an explanatory diagram illustrating an example of a case-by-case prediction model.

FIG. 30 It depicts an explanatory diagram illustrating examples of linear regression equations selected in the case-by-case prediction model.

FIG. 31 It depicts a block diagram of the information processing system according to the present invention, illustrating an example of a configuration of a fourth exemplary embodiment.

FIG. 32 It depicts an explanatory diagram illustrating an example of how to display the case-by-case prediction model.

FIG. 33 It depicts an explanatory diagram illustrating an example of how to display the case-by-case prediction model.

FIG. 34 It depicts a block diagram schematically illustrating the information processing system according to the present invention.

FIG. 35 It depicts a block diagram schematically illustrating an information processing device according to the present invention.

### DESCRIPTION OF EMBODIMENTS

In order to facilitate understanding, problems to be solved by the invention according to the present exemplary embodiment will be described in detail. A prediction model appropriately trained based on appropriate training data may be used not only for the purpose of predicting a value of a prediction target but also for the purpose of factor analysis of the prediction target.

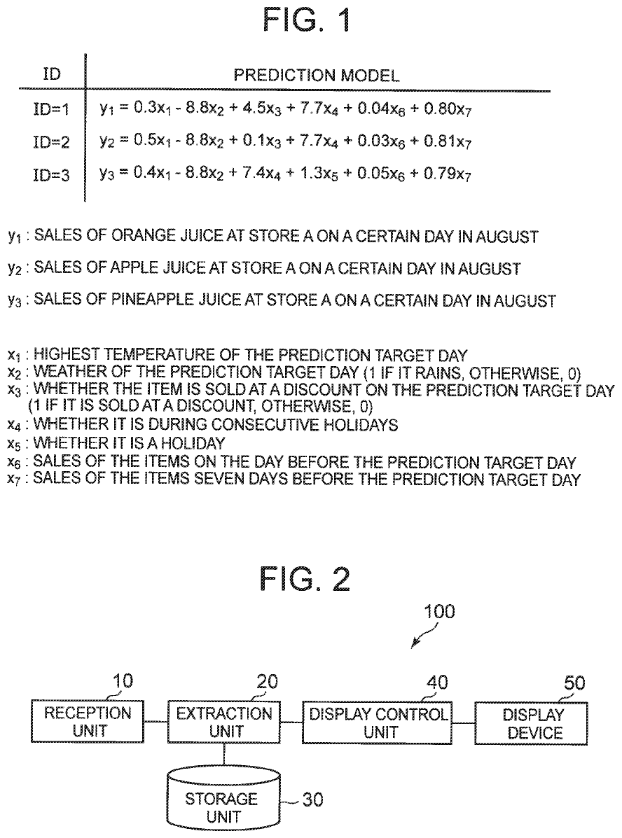

FIG. 1 is an explanatory diagram illustrating an example of a prediction model. FIG. 1 illustrates a plurality of prediction models. A prediction model corresponding to ID=1 is a prediction model used for predicting “how well orange juice sells at store A on a certain day in August”. A prediction model corresponding to ID=2 is a prediction model used for predicting “how well apple juice sells at store A on a certain day in August”. A prediction model corresponding to ID=3 is a prediction model used for predicting “how well pineapple juice sells at store A on a certain day in August”.

In practice, a value of each variable used in such a prediction model is standardized. Standardization is a process of adjusting a given data group to make the mean and variance of the data group equal to specific values. In general, such a data group is adjusted to have the mean equal to 0 and the variance equal to 1. Specifically, as shown below, the data group can be adjusted to have the mean equal to 0 and the variance equal to 1 by dividing, by a standard deviation, a value resulting from subtracting an average value from each piece of data.

Each piece of data after standardization=(each piece of data−average value)/standard deviation

Hereinafter, for ease of understanding, a description will be given of the prediction model using a variable before standardization (the same holds true for other exemplary embodiments). Further, such a variable used in the prediction model may be referred to as an explanatory variable.

According to the prediction models corresponding to ID=1, 2, and 3, since coefficients of a variable x₁ are all positive values, sales of juice at store A in August obviously have a positive correlation with the highest temperature of a prediction target day.

Further, according to the prediction models corresponding to ID=1, 2, and 3, since coefficients of a variable x₃ are positive values, it can be said that orange juice has a strong positive correlation with a discount sale. On the other hand, for apple juice and pineapple juice, since a coefficient of the variable x₃ is small or no variable x₃ is included in the prediction model, it is obvious that there is almost no correlation between the discount sale and sales. In other words, it can be said that sales of apple juice and pineapple juice are almost the same between with the discount sale and without the discount sale.

Such findings are of usefulness in devising a future marketing strategy. For example, it is predicted that the highest temperature is likely to rise in August of next year, it is conceivable that it is preferable to lay in a large stock of juice. Further, for apple juice and pineapple juice, it is possible to grasp the necessity of reviewing the discount sale. As described above, it is possible to analyze what kind of factors have contributed to sales based on the prediction model and to use the analysis result for devising a marketing strategy.

When a plurality of prediction targets is present, it is convenient that prediction models used for predicting prediction targets are listed for each prediction target. However, when the number of prediction targets becomes too large, it is difficult for a user to directly designate a prediction target that is of interest (that is, the user wants to see a prediction model corresponding to the prediction target) from among the large number of prediction targets.

For example, assume that a marketing manager belonging to a certain retail chain conducts a factor analysis of sales by analyzing prediction models for the past year. It is assumed that the prediction target is “how well a certain item will sell at a certain store in a certain month”. At this time, assuming that there are 5000 types of items per store, 100 stores are present, and information has been accumulated for one year, the number of prediction targets becomes 5000*100*12=6 million.

For example, assume that a serial number ID is assigned to each prediction target. At this time, in order for the user to list prediction models for the prediction target that is of interest, the user needs to know associations between 6 million prediction targets and 6 million IDs. This becomes a heavy burden on the user and thus is low in usability. As described above, when the number of prediction targets is large, it is difficult to use a prediction model for the purpose of factor analysis from the viewpoint of usability.

In the invention according to the present exemplary embodiment, a prediction model is identified by a classification rather than an ID. In a case where a prediction model is used for the purpose of factor analysis, this configuration makes it possible to provide an information processing system capable of conducting a factor analysis with high usability when there are a large number of prediction models.

A description will be given below of exemplary embodiments of the present invention with reference to the drawings. In the following description, it is assumed that each prediction target is predicted based on a prediction model, and such a prediction model is pretrained using past result data and the like. Further, one prediction model is associated with one prediction target.

The prediction model is information representing a correlation between an explanatory variable and an objective variable. The prediction model is a component used for predicting a result of the prediction target, for example, by calculating a target variable based on the explanatory variable. The prediction model is created by a learner with training data in which a value of the objective variable has already been obtained and any parameter as input. The prediction model may be represented by, for example, a function c that maps an input x to a correct outcome y. The prediction model may be configured to predict a numerical value of the prediction target or may predict a label of the prediction target. The prediction model may output a variable representing a probability distribution of the objective variable. The prediction model may be denoted as “model”, “learning model”, “estimation model”, “prediction equation”, “estimation equation”, or the like.

According to the present exemplary embodiment, the prediction model includes at least one variable that may affect the prediction target and a weight applied to the variable. In the prediction model, for example, the objective variable is represented by a linear regression equation including a plurality of explanatory variables. In the above example, the objective variable corresponds to the correct outcome y, and the explanatory variable corresponds to the input x. For example, the maximum number of explanatory variables included in one prediction model may be limited for the purpose of increasing interpretability of the prediction model or preventing overlearning. Note that a prediction equation used to predict one prediction target is not limited to one, and as will be described later, a case-by-case prediction model where a prediction equation is selected in accordance with a value of the explanatory variable may be used as the prediction model.

The prediction target belongs to at least one classification designated by the user. The classification may be a single entity or may have hierarchical structure. Taking a retail store as an example, the prediction target is, for example, “sales volume of orange juice sold at store A in Tokyo”. In this case, the prediction target is identified by a classification of sales store (Tokyo>A store) and a classification of item (drink>fruit drink>orange juice). Herein, the symbol “>” indicates that the classification has a hierarchical structure.

In addition, the prediction target is, for example, “sales volume of ballpoint pens sold under company A's private brand label at store B owned by the company A in March 2016”. In this case, the prediction target is identified by a classification of sales store (owned by company A>store B), a classification of sales time (2016>March 2016), and a classification of item (company A's private brand>stationery>ballpoint pen).

### First Exemplary Embodiment

FIG. 2 is a block diagram of the information processing system according to the present invention, illustrating an example of a configuration of a first exemplary embodiment. An information processing system 100 of the present exemplary embodiment includes a reception unit 10, an extraction unit 20, a storage unit 30, a display control unit 40, and a display device 50.

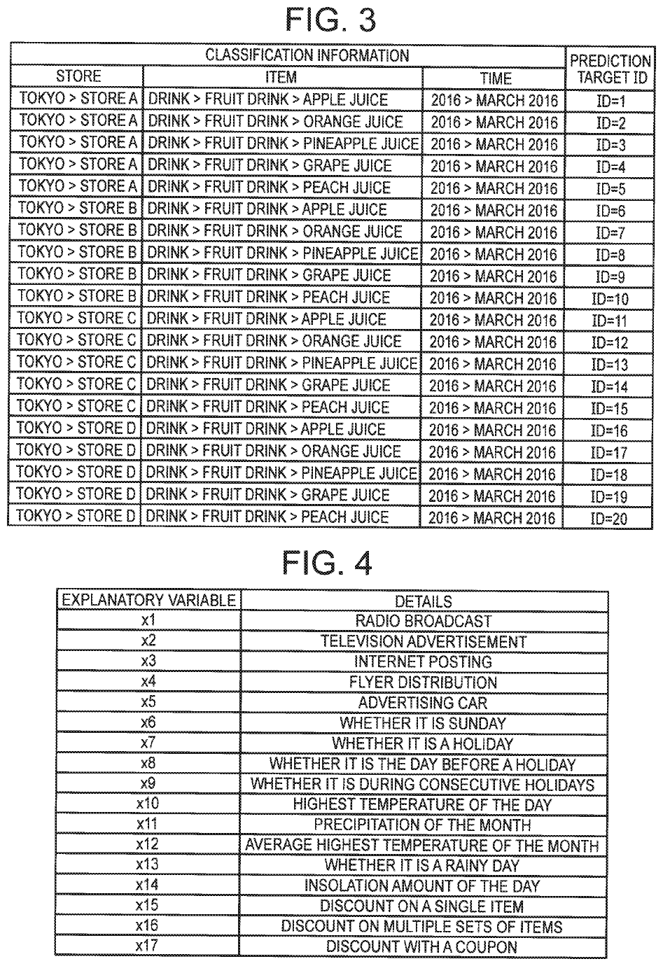

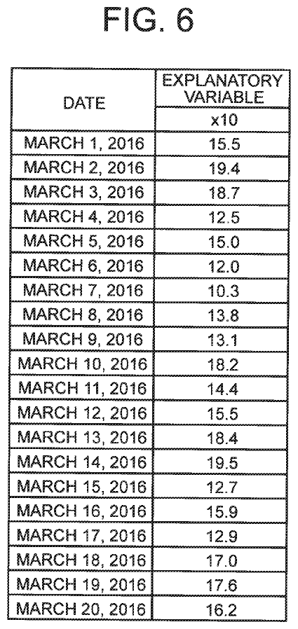

The storage unit 30 stores a prediction model for each prediction target. FIG. 3 to FIG. 6 are explanatory diagrams illustrating examples of information stored in the storage unit 30. The storage unit 30 may store a prediction target and a classification with the prediction target and the classification associated with each other. Further, the storage unit 30 may store a measured value of an explanatory variable. Herein, the measured value of the explanatory variable corresponds to, for example, a value of each explanatory variable actually measured as illustrated in FIG. 6.

FIG. 3 illustrates an example of how the storage unit 30 stores a prediction target and a plurality of classifications with the prediction target and the plurality of classifications associated with each other. In the example illustrated in FIG. 3, the prediction target is uniquely identified by a prediction target ID, and classifications “store”, “item”, and “time” are associated with each prediction target ID.

For example, a prediction target identified by a prediction target ID=1 is classified as store A in Tokyo from the viewpoint of “store”, classified as apple juice that is a fruit drink among drinks from the viewpoint of “item”, and classified as March 2016 from the viewpoint of “time”. Thus, it is preferable that the prediction model used for predicting demand for items or services is identified by a plurality of classifications such as a classification for items or services, a classification for geographical factors, and a classification for time factors.

In the above example, as the classification for items or services,

“fruit drink”, “apple juice”, and the like have been given. Further, as the classification for geographical factors, “Tokyo”, “store A”, and the like have been given, for example. Further, as the classification for time factors, “2016”, “March 2016”, and the like have been given, for example.

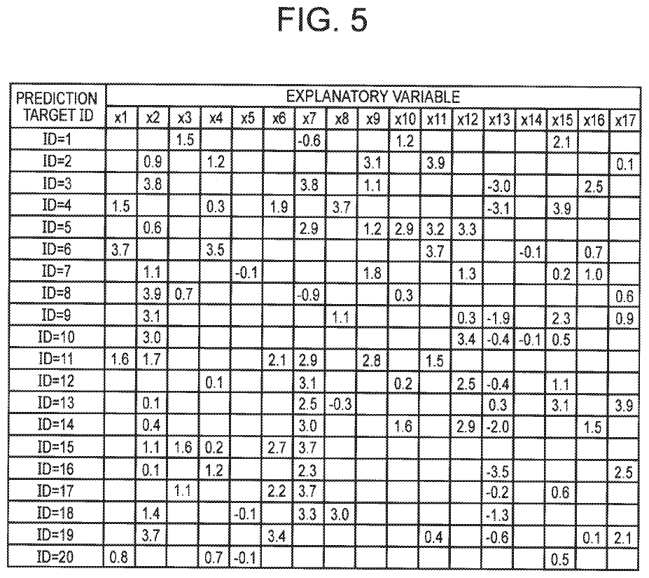

FIG. 4 illustrates examples of the explanatory variables. Further, FIG. 5 illustrates an example of how the storage unit 30 stores the prediction models of the prediction targets. Herein, assume that the explanatory variables illustrated in FIG. 4 are used in the prediction models illustrated in FIG. 5.

The example illustrated in FIG. 5 shows a prediction target in a vertical direction of the table, and weights of the explanatory variable representing the prediction model of the prediction target in a horizontal direction of the table. For example, the prediction model of the prediction target identified by the prediction target ID=1 is represented by explanatory variables x₃, x₇, x₁₀, x₁₅, and respective weights of the explanatory variables are 1.5, −0.6, 1.2, and 2.1. For example, when the prediction model is a linear regression equation, the prediction model of the prediction target identified by the prediction target ID=1 is represented by y=1.5x₃−0.6x₇+1.2x₁₀+2.1x₁₅, where y represents the objective variable. Note that the weight thus used may be a value of a coefficient itself or an absolute value of the coefficient.

According to the present exemplary embodiment, it is assumed that the prediction models illustrated in FIG. 5 are each configured to predict daily demand for an item. Note that even when the prediction model is configured to predict the daily demand for an item, the prediction model is updated over a span in accordance with an operation (for example, monthly or yearly). For example, the prediction models illustrated in FIG. 5 are each configured to predict the daily demand for an item at a certain store, but if the time is March 2016, it can be said that prediction based on the model is valid for one month. Further, a period during which the prediction based on the model is valid may be referred to as a model operation span. According to the present exemplary embodiment, it is assumed that the prediction model (prediction equation) is updated at the end of every month.

FIG. 6 illustrates specific examples of measured values of an explanatory variable. For example, when the explanatory variable x₁₀ is a variable representing “the highest temperature of the day”, each of the measured values illustrated in FIG. 6 is a value representing the highest temperature of each day actually measured. Note that, when a tallying period of the measured value and a tallying period the explanatory variable are different from each other, the measured value is tallied in accordance with a predetermined rule, and the tallying result may be used as a measured value of the explanatory variable. For example, when the explanatory variable represents “the highest temperature of the month” and the measured value represents “the highest temperature of each day”, the highest temperature in the month is identified, and then a value of the highest temperature may be used as the measured value.

The storage unit 30 is implemented by a magnetic disk device, for example.

The display device 50 is a device that presents various displays under control of the display control unit 40 (to be described later). The display device 50 is implemented by, for example, a display device or a touch panel.

The reception unit 10 receives a classification used for identifying a prediction target. In other words, the reception unit 10 receives at least one of the plurality of classifications used for identifying the prediction target. Note that the classification received by the reception unit 10 is not a classification itself such as “store” illustrated in FIG. 3 but a specific value of the classification “store” (for example, “store A”). In the following description, the classification itself and a specific value of the classification used for identifying a certain prediction target are expressed as “classification” without distinction.

The reception unit 10 may receive not only one classification, but also a plurality of classifications. For example, when extracting a prediction model used for predicting “apple juice” at each store in March 2016, the reception unit 10 receives “March 2016” and “apple juice” as classifications. Further, when the classification has a hierarchical structure, the reception unit 10 may receive not only the lowest-level classification but also an upper-level classification. For example, the reception unit 10 may cause the display device 50 to display candidate classifications and receive at least one classification selected by the user. In addition, the reception unit 10 may receive the classification over a communication network.

Further, the reception unit 10 may receive various types of information designated by the user through processing (to be described later).

The extraction unit 20 makes a query used for extracting a prediction model based on the classification thus received, and extracts the prediction model from the storage unit 30 based on the query thus made.

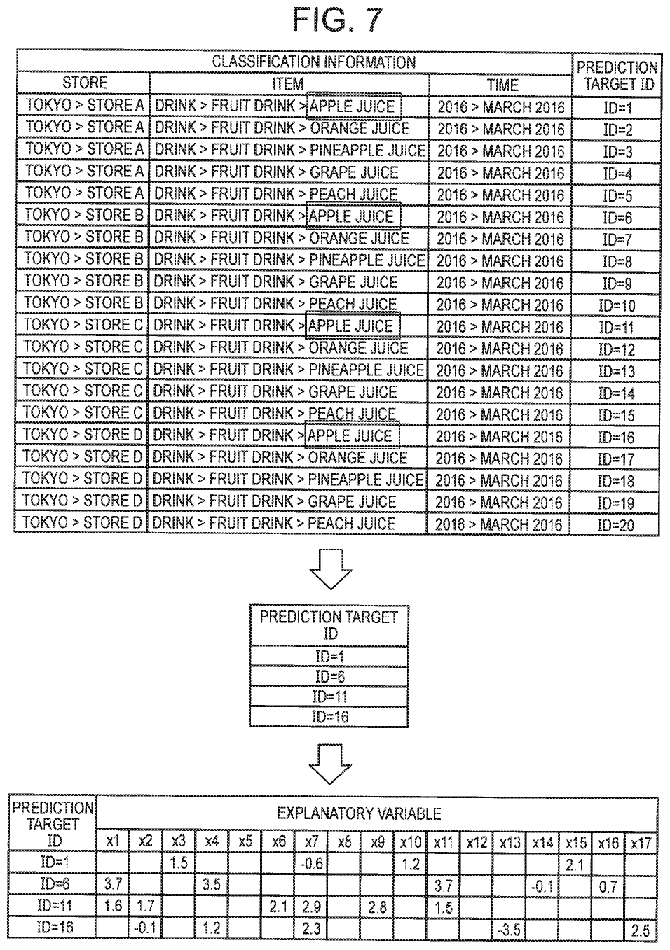

FIG. 7 is an explanatory diagram illustrating an example of processing of extracting a prediction model from the information illustrated in FIG. 3 to FIG. 6 based on the received classification. For example, in order to conduct a factor analysis of “apple Juice” at each store in March 2016, the reception unit 10 receives “March 2016” and “apple Juice” as classifications. For example, the extraction unit 20 makes a query “time=‘March 2016’ AND item=‘apple juice’” based on the classification thus received.

Then, the extraction unit 20 identifies prediction targets assigned with the prediction target ID=1, 6, 11, 16 and associated with item=“apple juice” and time=“March 2016” from the table illustrated in FIG. 3. Then, the extraction unit 20 extracts prediction models for the prediction targets from the table shown FIG. 5.

Further, when any of the classifications has a hierarchical structure as described above, the reception unit 10 may receive not only a lower-level classification but also an upper-level classification. In this case, the extraction unit 20 determines that all lower-level classifications belonging to the classification thus received are designated. Then, the extraction unit 20 may extract, based on the query including the upper-level classification thus received, a plurality of prediction models identified by the lower-level classifications included in the upper-level classification from the storage unit 30.

For example, in the example illustrated in FIG. 3, it is assumed that “fruit drink” is designated as the classification for items. In this case, the extraction unit 20 determines that “orange juice”, “apple juice”, “pineapple juice”, “grape juice”, and “peach juice” that are lower-level classifications of “fruit drink” have been designated, and identifies, with “ store A” designated, prediction targets identified by the prediction target ID=1 to 5.

The display control unit 40 controls the display device 50 to cause the display device 50 to display an extracted prediction model. In the following description, that the display control unit 40 controls the display device 50 to cause the display device 50 to display is simply referred to as that the display control unit 40 displays.

The display control unit 40 displays a plurality of extracted prediction models in a comparable manner. Specifically, the display control unit 40 displays variables and weights of the variables included in the extracted prediction models with the variables and the weights associated with each other. For example, the display control unit 40 may display a prediction equation representing a prediction model. Note that when displaying a plurality of prediction models, the display control unit 40 preferably displays weights of the same variables in a manner as to make the weights aligned in the same column. Further, the display control unit 40 may receive explanatory variables designated by the user through the reception unit 10 and sort the prediction models in descending order of the weights of the explanatory variables thus designated.

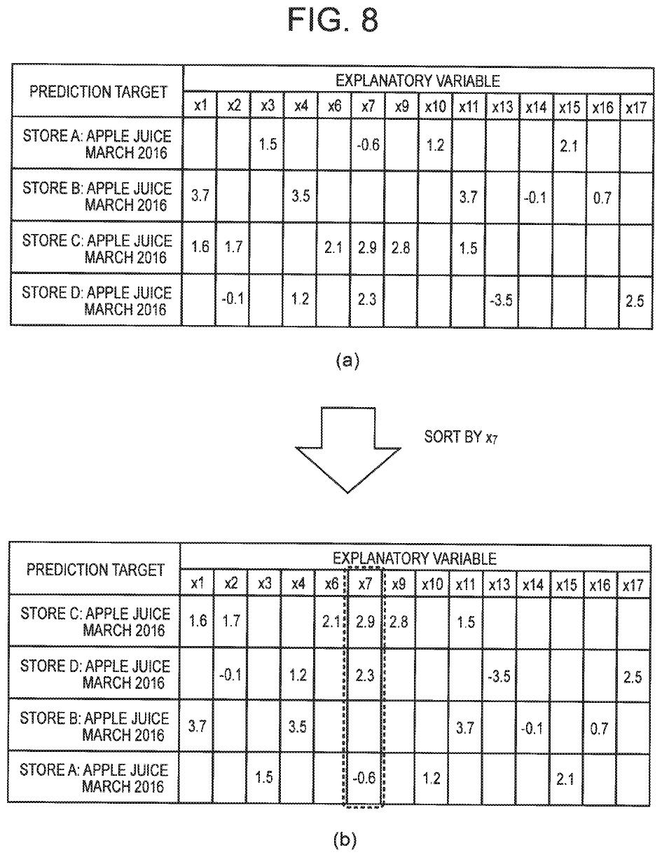

FIG. 8 is an explanatory diagram illustrating an example of how to display extracted prediction models. Extraction results illustrated in FIG. 8 are the same as the extraction results illustrated in FIG. 7. As illustrated in FIG. 8(a), the display control unit 40 may display weights of the same explanatory variables in a manner as to make the weights aligned in the same column. For example, when x₇ is designated as an explanatory variable, the display control unit 40 may sort and display prediction models into descending order of the weights of x₇ as illustrated in FIG. 8(b).

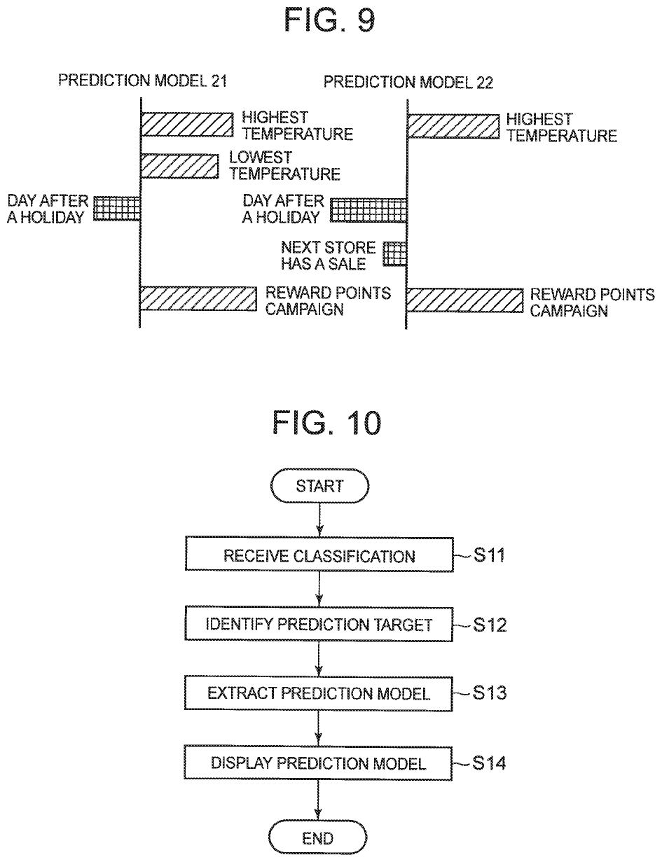

Further, the display control unit 40 may graph and display the weights for each extracted prediction model. FIG. 9 is an explanatory diagram illustrating an example where weights of prediction models are graphed. In the example illustrated in FIG. 9, two prediction models are given as examples. It is preferable that the display control unit 40 displays the weights of the same explanatory variables in a manner as to make the weights aligned in the horizontal direction, so as to make the weights comparable between the prediction models. Further, the display control unit 40 may separately display positive weights (coefficients) on a right side and negative weights (coefficients) on a left side, and may change the form of the graph depending on whether the weight is a positive or negative value.

In the example illustrated in FIG. 9, the “highest temperature” of a prediction model 21 has a positive correlation with sales, and the “day after a holiday” has a negative correlation with the sales. In the example illustrated in FIG. 9, “the next store has a sale” of the prediction model 21 does not contribute to the sales, but is displayed with a space provided to make the prediction model 21 easily compared with the prediction model 22.

The reception unit 10, the extraction unit 20, and the display control unit 40 are implemented by a CPU of a computer that operates in accordance with a program (information processing program). For example, the program may be stored in the storage unit 30, and the CPU may load the program and then operate as the reception unit 10, the extraction unit 20, and the display control unit 40 in accordance with the program. Further, the capability of the information processing system may be provided through software as a service (SaaS).

Further, the reception unit 10, the extraction unit 20, and the display control unit 40 may be each implemented by dedicated hardware. Further, some or all of the components of each device are implemented by general-purpose or dedicated circuitry, a processor, and the like, or a combination thereof. These components may be formed on a single chip or may be formed on a plurality of chips connected via a bus. Further, some or all of the components of each device may be implemented by a combination of the above-described circuitry and the like, and the program.

Further, in a case where some or all of the components of each device are implemented by a plurality of information processing devices, or circuitry and the like, the plurality of information processing devices, or the circuitry and the like may be arranged in a concentrated manner or in a distributed manner. For example, the information processing devices, or the circuitry and the like may be implemented in a form such as a client and server system or a cloud computing system in which nodes are connected over a communication network.

Further, the information processing system of the present exemplary embodiment may be implemented by a single information processing device such as a tablet. In this case, the information processing device may include the reception unit 10 and the extraction unit 20 that extracts a prediction model from the storage unit 30.

Next, a description will be given of the operation of the information processing system of the present exemplary embodiment. FIG. 10 is a flowchart illustrating an example of an operation of the information processing system 100 of the first exemplary embodiment. First, the reception unit 10 receives a classification used for identifying a prediction target (step S11). Next, the extraction unit 20 identifies the prediction target based on the classification thus received (step S12), and extracts a prediction model associated with the prediction target thus identified (step S13). Then, the display control unit 40 displays the prediction model thus extracted on the display device 50 (step S14).

As described above, according to the present exemplary embodiment, the reception unit 10 receives at least one of the plurality of classifications, and the extraction unit 20 extracts a prediction model from the storage unit 30 based on the classification received by the reception unit 10. Therefore, in a case where the prediction model is used for the purpose of factor analysis, even when a large number of prediction models are present, it is possible to conduct the factor analysis using these prediction models with high usability.

That is, according to the present exemplary embodiment, a prediction model is extracted based on a desired classification designated from among the plurality of classifications by which a prediction model can be identified, rather than an identification ID or the like. This makes it possible to extract only a prediction model necessary for factor analysis. Therefore, the user can select, from a large number of prediction targets, a prediction model corresponding to a prediction target that is of interest from various viewpoints (store, item, time, and the like), display the prediction model, and then conduct an analysis.

Note that FIG. 5 illustrates only about 20 prediction models, but as described with reference to FIG. 1, it is conceivable that there are several million prediction models for the prediction target. As described above, when there are a large number of prediction models, the present invention exhibits a more remarkable effect.

For example, assume that the user wants to analyze a difference in sales trend of orange juice between store A and store B. At this time, the user may designate “store A”, “store B”, and “orange juice” as classifications. When the reception unit 10 receives such designation, the extraction unit 20 extracts the prediction models assigned with ID=2 and ID=7 illustrated in FIG. 5.

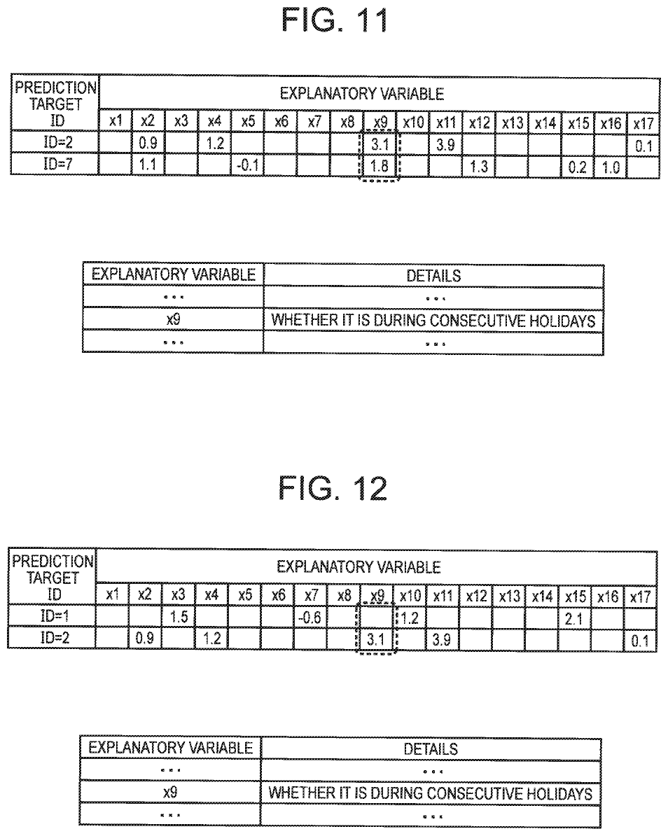

FIG. 11 is an explanatory diagram illustrating examples of extracted prediction models. A result of comparing the extracted prediction models shows that, for example, “whether it is during consecutive holidays” indicated by the explanatory variable x₉ contributes to both the sales of orange juice at store A and the sales of orange juice at store B, but contributes to store A with a larger degree than store B (3.1>1.8). The user can conduct an analysis such as “is it due to the difference in location between store A and store B?” or “is there a facility near store A where many people visit during consecutive holidays?”. In addition, from this analysis, the user can devise a countermeasure such as “when the latter holds true, a further study of the facility may bring about an idea of attracting customers to store A”.

In addition, for example, assume that the user wants to analyze a difference in sales trend between orange juice and apple juice at store A. At this time, the user may designate “orange juice”, “apple juice”, and “store A” as classifications. When the reception unit 10 receives such designation, the extraction unit 20 extracts prediction models assigned with ID=1 and ID=2 illustrated in FIG. 5.

FIG. 12 is an explanatory diagram illustrating different examples of extracted prediction models. A result of comparing the extracted prediction models shows that, for example, orange juice sells well during consecutive holidays (the coefficient of x₉ is a large positive coefficient), while whether it is during consecutive holidays does not contribute to the sales of apple juice at all (x₉ is not included as an explanatory variable). The user can conduct an analysis such as “is there a commonality between a group of customers who visit the facility and a group of customers who like orange juice?”.

As described above, the use of the information processing system 100 of the present exemplary embodiment makes it possible to analyze a sales trend of an item from various viewpoints such as for each store, for each item, and for each time.

### Second Exemplary Embodiment

Next, a description will be given of a second exemplary embodiment of the information processing system according to the present invention. For the first exemplary embodiment, the description has been given of the method of displaying prediction models for each explanatory variable. On the other hand, it is conceivable that the number of explanatory variables used for prediction becomes very large. That is, when a factor used in analysis is divided into too small portions, the number of explanatory variables becomes very large, which may affect interpretability.

The reason why the number of explanatory variables becomes very large will be described below with reference to a specific example. For example, when a company with 1000 retail stores nationwide predicts sales volumes of 2000 types of items per store on a monthly basis, the number of prediction models becomes 1000 (stores)*12 (months per year)*2000 (types per month and store)=24000000 per year.

Herein, assume that an operator wants to conduct a factor analysis of nationwide sales of a specific item in a specific month. In this case, the reception unit 10 receives classifications of “March 2016” and “orange juice” from the user as classifications used for identifying a prediction target for a sales volume. Prediction models for 1000 stores are identified by the classifications received by the reception unit 10. In other words, the extraction unit 20 extracts the prediction models used for predicting the sales volume of orange juice at each of the 1000 stores on a certain day in March 2016.

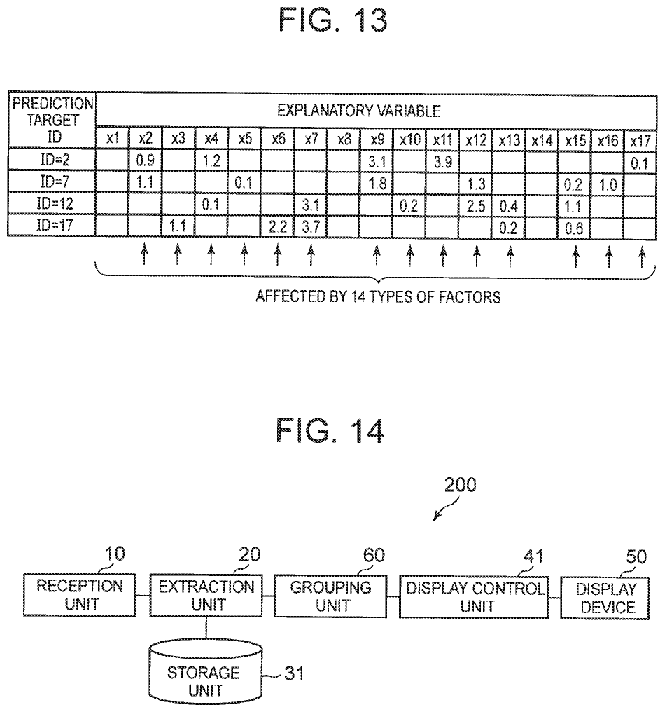

On the other hand, as the number of prediction models increases, the number of types of explanatory variables included in the prediction models also increase. This will be described using the prediction models illustrated in FIG. 5 as an example. FIG. 13 is an explanatory diagram illustrating an example of processing of conducting a factor analysis based on a plurality of prediction models. Herein, assume that a factor analysis of sales of orange juice at each of store A to store D on a certain day in March 2016 is conducted. Even for the same item (for example, orange juice) at the same time (for example, March 2016), it is likely that a factor (that is, an explanatory variable) that contributes to the sales varies from store to store.

In the example illustrated in FIG. 13, it is considered to take factors indicated by the explanatory variables x₂, x₄, x₉, x₁₁, x₁₇ included in the prediction model identified by the prediction target ID=2 as factors (that is, explanatory variables) that contribute to the sales of orange juice at store A. On the other hand, it is considered to take factors indicated by the explanatory variables x₂, x₅, x₉, x₁₂, x₁₅, x₁₆ included in the prediction model identified by the prediction target ID=7 as factors (that is, explanatory variables) that contribute to the sales of orange juice at store B. Similarly, for store C, it is considered to take factors indicated by the explanatory variables x₄, x₇, x₁₀, x₁₂, x₁₃, x₁₅ included in the prediction model identified by the prediction target ID=12, and for store D, it is considered to take factors indicated by the explanatory variables x₃, x₆, x₇, x₁₃, x₁₅ included in the prediction model identified by the prediction target ID=17.

A result of tallying all these factors shows that the sales of orange juice at each of store A to store D in March 2016 are affected by the (14 types of) factors indicated by the explanatory variables x₂, x₃, x₄, x₅, x₆, x₇, x₉, x₁₀, x₁₁, x₁₂, x₁₃, x₁₅, x₁₆, x₁₇. However, too many explanatory variables to be considered may affect interpretability. That is, too many kinds of explanatory variables included in the prediction model may make the tallying result difficult for humans to interpret. As described above, even when the number of explanatory variables constituting one prediction equation is not so large, the number of types of included explanatory variables may increase as the number of prediction equations increases. Therefore, for the present exemplary embodiment, a description will be given of a method that allows factors that possibly contribute to the prediction target to be analyzed from broader viewpoints.

FIG. 14 is a block diagram of the information processing system according to the present invention, illustrating an example of a configuration of a second exemplary embodiment. An information processing system 200 of the present exemplary embodiment includes the reception unit 10, the extraction unit 20, a storage unit 31, a display control unit 41, the display device 50, and a grouping unit 60. Respective operations of the reception unit 10, the extraction unit 20, and the display device 50 are the same as the operations in the first exemplary embodiment.

As in the first exemplary embodiment, the storage unit 31 stores a prediction model for each prediction target. Furthermore, the storage unit 31 of the present exemplary embodiment stores associations between variables used in prediction models (that is, explanatory variables) and categories to which the variables belong. That is, according to the present exemplary embodiment, categories indicating properties of variables are set. However, such categories may be set to the explanatory variables of the first exemplary embodiment.

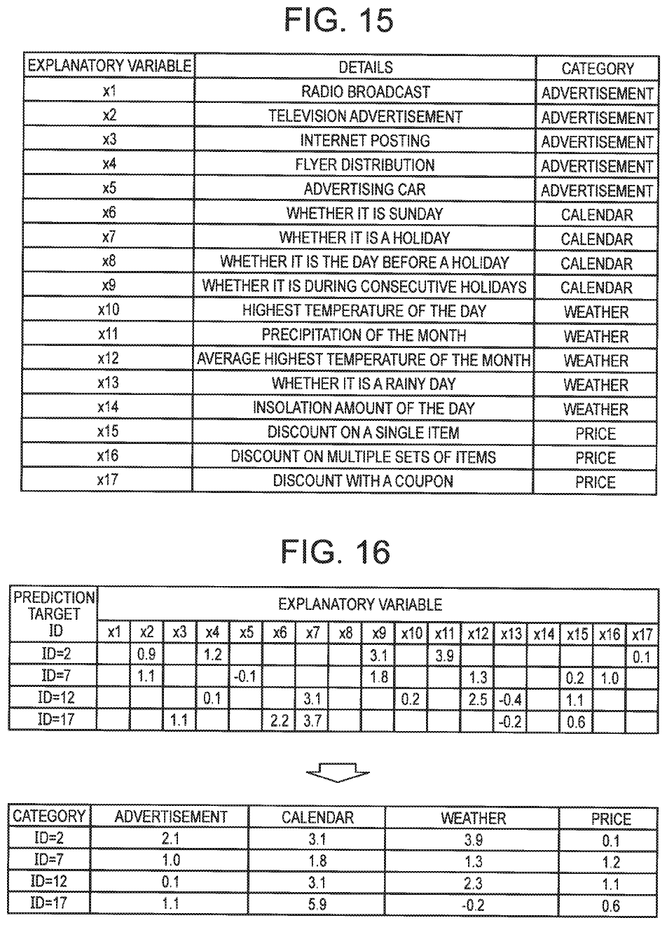

FIG. 15 is an explanatory diagram illustrating examples of explanatory variables to which the categories are set. For example, when the prediction model includes explanatory variables such as “television advertisement”, “internet posting”, and “flyer distribution”, for example, a category “advertisement” is set to these explanatory variables. In addition, for example, assuming that the prediction target is predicted every day, when the prediction model includes explanatory variables such as “whether it is Sunday”, “whether it is a holiday”, “whether it is the day before a holiday”, and the like, a category “calendar” is set to these explanatory variables, for example. Further, for example, assuming that the prediction target is predicted every day, when the prediction model includes explanatory variables such as “whether it is a rainy day”, “highest temperature”, and “insolation amount”, a category “whether” is set to these explanatory variables. It is assumed that a relation between an explanatory variable and a category to which the explanatory variable belongs is predetermined, for example.

The grouping unit 60 groups, for each prediction model extracted by the extraction unit 20, weights of a plurality of variables included in the prediction model for each category corresponding to the explanatory variables. Specifically, the weight of a variable is a coefficient of an explanatory variable.

The grouping unit 60 may calculate a weight for each category by adding all coefficients of explanatory variables belonging to the same category. At this time, the grouping unit 60 may take the weight of each explanatory variable as a coefficient including a sign or an absolute value of a coefficient.

FIG. 16 is an explanatory diagram illustrating an example of processing of grouping weights for each category. For example, assume that the extraction unit 20 has extracted four prediction models identified by ID=2, 7, 12, 17. When the variables and the categories to which the variables belong have associations illustrated in FIG. 15, the grouping unit 60 groups the coefficients of the explanatory variables x₁ to x₅ as the weight of the “advertisement” category. Similarly, the grouping unit 60 groups the coefficients of the explanatory variables x₆ to x₉ as the weight of the “calendar” category, groups the coefficients of the explanatory variables x₁₀ to x₁₄ as the weight of the “whether” category, and groups the coefficients of the explanatory variables x₁₅ to x₁₇ as the weight of a “price” category. FIG. 16 shows results of adding the coefficients including the sign.

In the example illustrated in FIG. 13, there are 14 types of factors (that is, explanatory variables), but the factors are tallied for each category and then grouped into four types of categories “advertisement”, “calendar”, weather”, and “price”. Further, tallying a large number of similar explanatory variables in this way makes it possible to increase the interpretability of factors. For example, in the example illustrated in FIG. 16, it is easily determined at a glance that the factors relating to “calendar” have a larger impact than the factors relating to “advertisement” and “price”.

The display control unit 41 groups the weights of the variables included in the extracted prediction model for each category and causes the display device 50 to display the weights. For example, the display control unit 41 causes the display device 50 to display the results illustrated in FIG. 16.

Note that the reception unit 10, the extraction unit 20, the display control unit 41, and the grouping unit 60 are implemented by a CPU of a computer that operates in accordance with a program (information processing program).

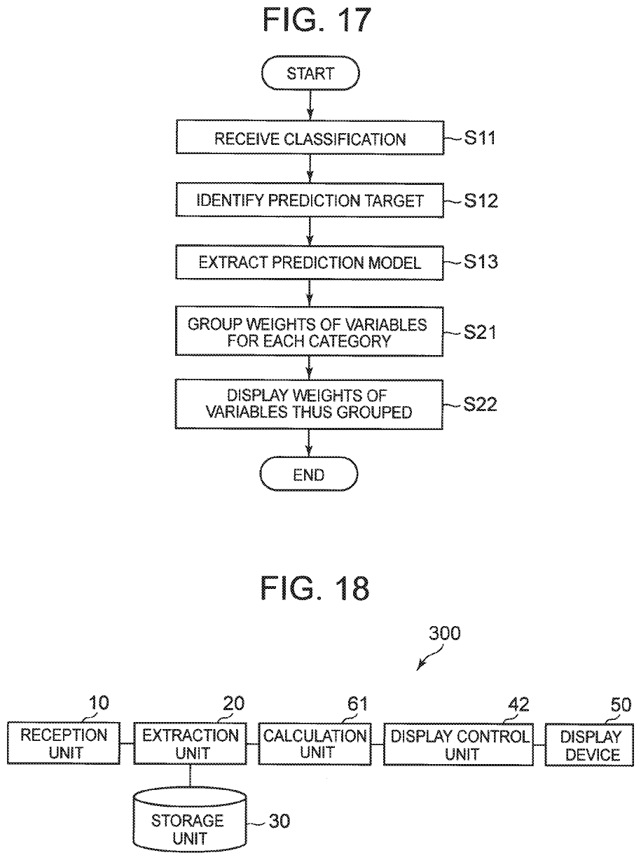

Next, a description will be given of the operation of the information processing system of the present exemplary embodiment. FIG. 17 is a flowchart illustrating an example of an operation of the information processing system 200 of the second exemplary embodiment. Note that step S11 to step S13 from when the reception unit 10 receives a classification to when the extraction unit 20 extracts a prediction model are the same as the steps illustrated in FIG. 10.

The grouping unit 60 groups, for each prediction model extracted by the extraction unit 20, weights of a plurality of variables included in the prediction model for each category corresponding to the variables (step S21). Then, the display control unit 41 causes the display device 50 to display the weights of the variables grouped for each category (step S22).

As described above, according to the present exemplary embodiment, the grouping unit 60 groups the weights of the plurality of variables included in the prediction model for each category. Therefore, in addition to the effects of the first exemplary embodiment, it is possible to conduct an analysis from broader viewpoints.

### THIRD EXEMPLARY EMBODIMENT

Next, a description will be given of a third exemplary embodiment of the information processing system according to the present invention. For the first exemplary embodiment and the second exemplary embodiment, the description has been given of the method where a coefficient is used as the weight of a variable. The present exemplary embodiment is different from the first exemplary embodiment and the second exemplary embodiment in that a measured value of an explanatory variable is taken into consideration.

FIG. 18 is a block diagram of the information processing system according to the present invention, illustrating an example of a configuration of the third exemplary embodiment. An information processing system 300 of the present exemplary embodiment includes the reception unit 10, the extraction unit 20, the storage unit 30, a display control unit 42, the display device 50, and a calculation unit 61. Respective operations of the reception unit 10, the extraction unit 20, the storage unit 30, and the display device 50 are the same as the operations in the first exemplary embodiment.

For an extracted prediction model, the calculation unit 61 calculates, for each variable, a product of a coefficient of a variable included in the prediction model and a value of the variable as a weight of the variable. In the following description, the product of the coefficient of the variable and the value of that variable is referred to as a degree of contribution. Then, the display control unit 42 displays the degree of contribution thus calculated with the degree of contribution and the variable associated with each other.

A description will be given below on the assumption that the prediction model is represented by a linear regression equation including a plurality of explanatory variables. The extraction unit 20 identifies a prediction target based on a received classification and extracts a prediction model for the prediction target thus identified. At the same time, the extraction unit 20 extracts measured values of the explanatory variables included in the prediction model based on the received classification. The measured values are, for example, as illustrated in FIG. 6 and are stored in the storage unit 30. Then, the calculation unit 61 calculates, for each explanatory variable in the linear regression equation, the product of the weight (coefficient) of the explanatory variable and the measured value of the explanatory variable.

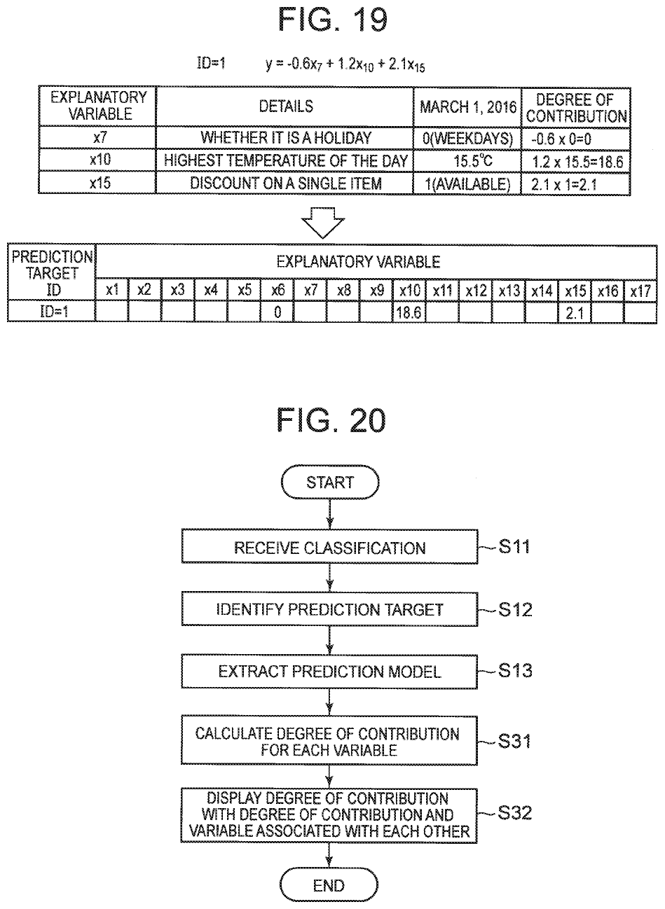

FIG. 19 is an explanatory diagram illustrating an example of processing of calculating the degree of contribution. For example, the prediction model identified by ID=1 includes three explanatory variables (x₇, x₁₀, x₁₅). Herein, assume that Mar. 1, 2016 is a weekday, the highest temperature is 15.5 degrees based on the example illustrated in FIG. 6, and a discount on a single item is available. In this case, x₇=0, x₁₀=15.5, and x₁₅=1. Note that as described in the first exemplary embodiment, a value of data is preferably standardized. Herein, in order to simplify the description, the measured value itself will be used.

The calculation unit 61 calculates a product (=0) of the coefficient −0.6 of x₇ and the measured value 0 as a degree of contribution. Similarly, the calculation unit 61 calculates a product (=18.6) of the coefficient 1.2 of x₁₀ and the measured value 15.5 as a degree of contribution, and calculates a product (=2.1) of the coefficient 2.1 of x₁₅ and the measured value 1 as a degree of contribution.

Note that the reception unit 10, the extraction unit 20, the display control unit 42, and the calculation unit 61 are implemented by a CPU of a computer that operates in accordance with a program (information processing program).

Next, a description will be given of the operation of the information processing system of the present exemplary embodiment. FIG. 20 is a flowchart illustrating an example of an operation of the information processing system 300 of the third exemplary embodiment. Note that step S11 to step S13 from when the reception unit 10 receives a classification to when the extraction unit 20 extracts a prediction model are the same as the steps illustrated in FIG. 10.

The calculation unit 61 calculates, for each variable included in the extracted prediction model, the product (that is, the degree of contribution) of the coefficient of the variable and the value of the variable (step S31). Then, the display control unit 42 causes the display device 50 to display the degree of contribution thus calculated with the degree of contribution and the variable associated with each other (step S32).

As described above, according to the present exemplary embodiment, the calculation unit 61 calculates, for each variable included in the prediction model, the product of the coefficient of the variable and the value of the variable. Therefore, in addition to the effects of the first exemplary embodiment, it is possible to conduct an analysis reflecting the measured value.

A description will be given below in detail of the effects of the present exemplary embodiment with reference to a specific example. For example, assume that “the sales volume of orange juice at store A on a certain day in March 2016” is described with reference to the following prediction equation. In the equation, the parentheses represent explanatory variables.

Sales volume=−11.3*(highest temperature of the month near store A)+60*(total precipitation of the day near store A)+130.

When a determination is made only from the above equation, it seems that the total precipitation of the day greatly contributes to the sales volume of orange juice at store A on a certain day in March because a value of the coefficient is large. However, assume that there is no rainfall near store A on a certain day in March. In this case, it can be said that, in fact, the total precipitation of the day near store A does not contribute to the sales volume of orange juice at store A on a certain day in March at all.

Therefore, according to the present exemplary embodiment, the degree of contribution of the explanatory variable is calculated as a value of the product of “the value of the coefficient in the prediction equation” and “the measured value of the explanatory variable to which the coefficient is applied”, thereby making it possible to conduct an analysis reflecting the measured value as compared to the first exemplary embodiment.

Note that degrees of contribution thus calculated may be grouped for each category. That is, the information processing system 300 of the present exemplary embodiment may include the grouping unit 60 of the second exemplary embodiment, and the storage unit 30 may be implemented as the storage unit 31. Then, the grouping unit 60 may group the degrees of contribution calculated by the calculation unit 61 for each category.

Next, a description will be given of a modification of the third exemplary embodiment. For the third exemplary embodiment, the description has been given of the method of calculating the degree of contribution based on the measured value. On the other hand, it is also possible to predict the result based on the prediction model. In this case, it is possible to determine a difference (error) between the prediction result based on the prediction model and the measurement result actually obtained. Therefore, the calculation unit 61 may correct the degree of contribution based on an error that is the difference between the prediction result based on the prediction model and the measurement result actually obtained.

For example, for each prediction target, the calculation unit 61 may correct the degree of contribution of each explanatory variable at the same ratio based on the difference between the prediction result and the actual measurement result. For example, when the measurement result has a value twice the value of the prediction result, the calculation unit 61 may double the degree of contribution of each explanatory variable.

In addition, for example, the calculation unit 61 may define a new explanatory variable indicating the difference between the prediction result and the measurement result, and use the difference as the degree of contribution degree of the new explanatory variable.

Note that the method by which the calculation unit 61 corrects the degree of contribution in accordance with the error is not limited to the above-described example. The calculation unit 61 may change the ratio at which the degree of contribution is corrected and define at least two new explanatory variables.

Hereinafter, for the first to third exemplary embodiments, a description will be given of a specific example where the display control unit 40, the display control unit 41, or the display control unit 42 (hereinafter, simply referred to as a display control unit) causes the display device 50 to display a variable included in an extracted prediction model and a weight of the variable with the variable and the weight associated with each other. In this specific example, it is assumed that prediction models identified based on the information illustrated in FIG. 3 and FIG. 5 are stored in the storage unit 30.

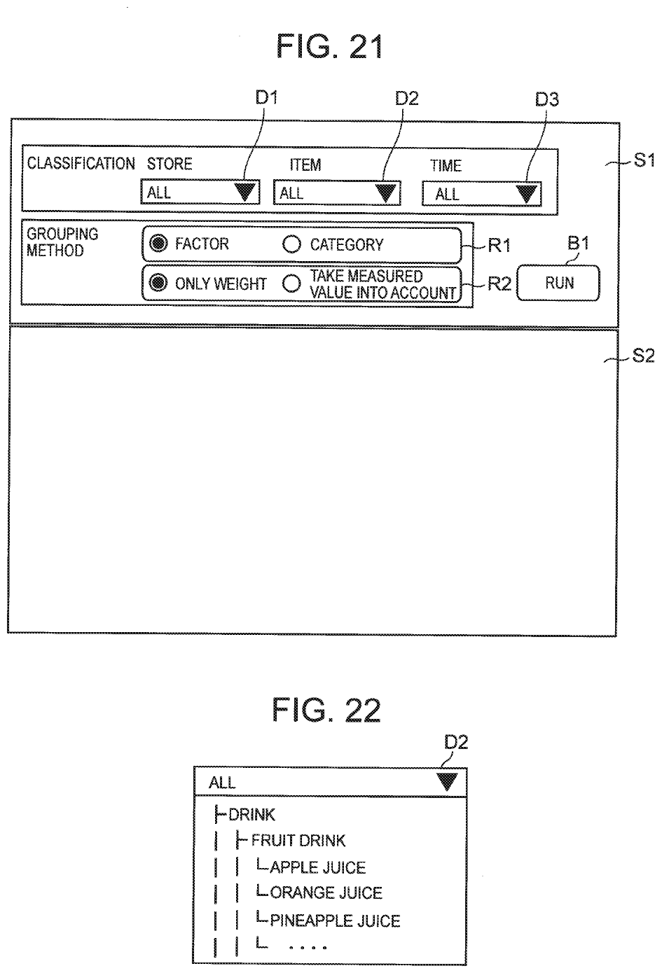

FIG. 21 is an explanatory diagram illustrating an example of a screen displayed on the display device 50 by the display control unit. The screen illustrated in FIG. 21 shows an initial state. Specifically, this screen has a screen S1 for designating an extraction target at the top and a screen S2 for displaying an extraction result at the bottom.

Further, in the example illustrated in FIG. 21, provided on the screen S1 are drop-down lists D1 to D3 of classifications used for identifying a prediction target. FIG. 22 is an explanatory diagram illustrating an example of information included in a drop-down list. In the example illustrated in FIG. 22, a fruit drink is included as one of drinks in the classification for items, and further, a plurality of types of juice are included in the classification for fruit drinks. With consideration given to the configuration where the classification has a hierarchical structure, the display control unit may display the extraction result in accordance with a level of the classification.

Further, for designation of a grouping method, the screen S1 is provided with a radio button R1 used for selecting whether to display the factors alone or to group the factors for each category. The screen S1 is further provided with a radio button R2 used for selecting whether to display the weight of the explanatory variable as it is or to display the degree of contribution that takes the measured value into account.

When the user selects a classification and grouping method and presses a run button B1 illustrated in FIG. 21, the reception unit 10 and the extraction unit 20 perform extraction processing, and the display control unit displays the extraction result on the screen S2.

Hereinafter, a description will be given of an example of a tallying result when a factor analysis from two kinds of viewpoints is requested from the user. The first type is a factor analysis of sales of orange juice at all stores in Tokyo (that is, store A, store B, store C, and store D) in March 2016, and the second type is a factor analysis of sales of all the fruit drinks (apple juice, orange juice, pineapple juice, grape juice, and peach juice) at a specific store (store A) in March 2016.

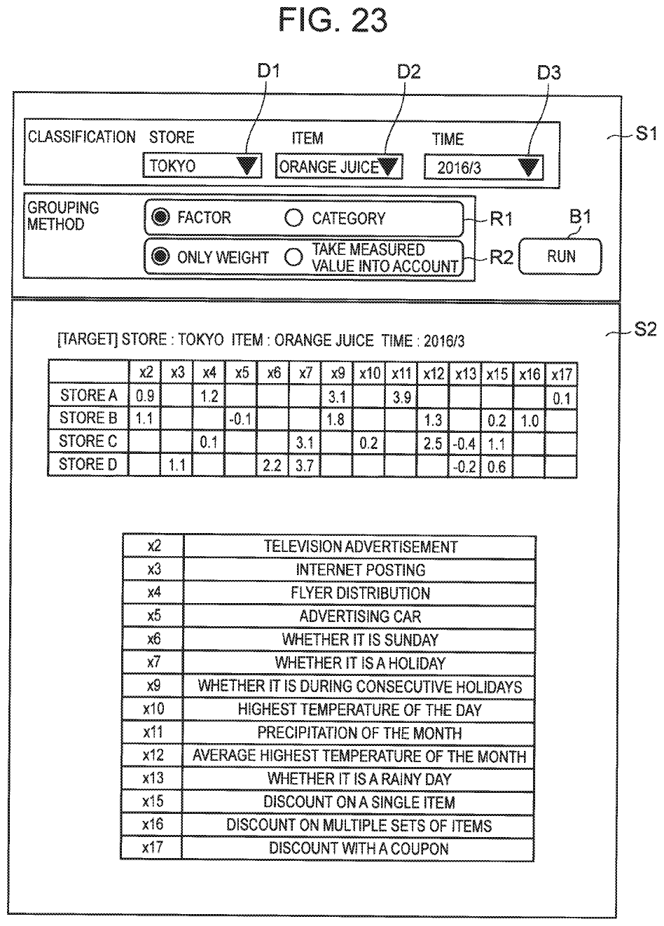

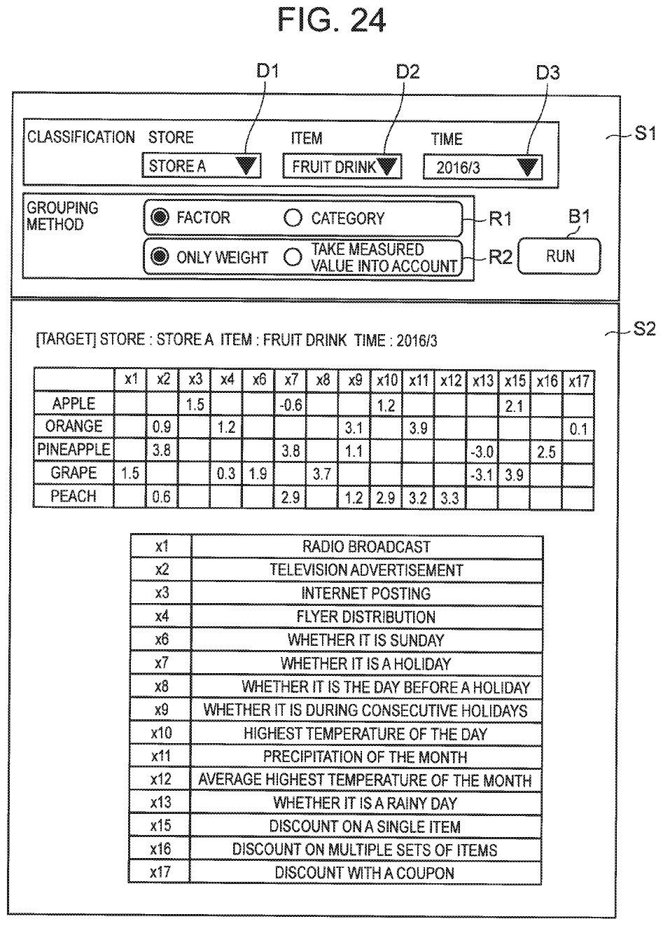

FIG. 23 to FIG. 27 are explanatory diagrams illustrating examples of result screens displayed by the display control unit. FIG. 23 illustrates an example of a result of outputting factors of sales of orange juice at all stores in Tokyo. Further, FIG. 24 illustrates an example of a result of outputting factors of sales of all the fruit drinks at store A.

Performing output under designated conditions makes it possible to narrow down prediction models in accordance with the user's viewpoint, as illustrated in FIG. 23 and FIG. 24. That is, the use of the information processing system of the present invention makes it possible to analyze factors that possibly contribute to the prediction target from various viewpoints.

Note that as illustrated in FIG. 23 and FIG. 24, as the number of target prediction models increases, the number of factors (explanatory variables) that possibly contribute also increases. Therefore, as described in the second exemplary embodiment, tallying the factors (explanatory variables) for each category makes it possible to increase ease of interpretation.

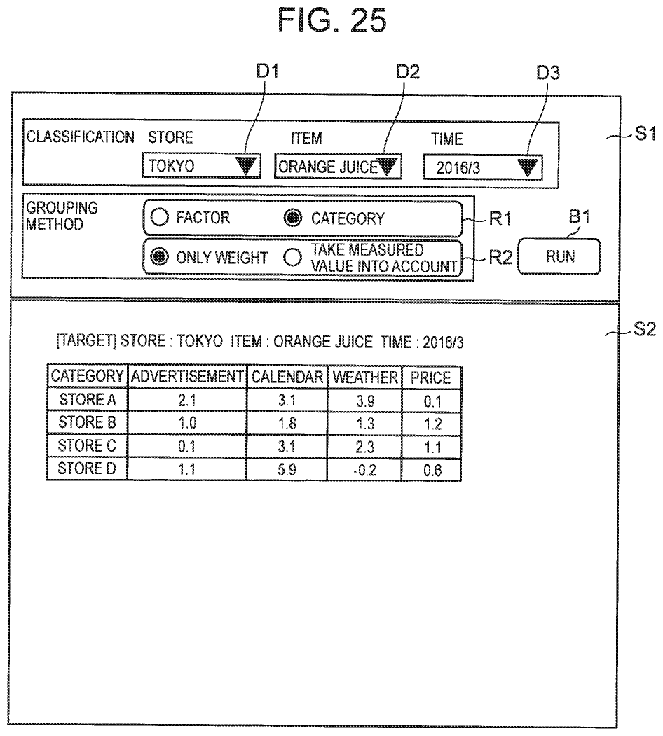

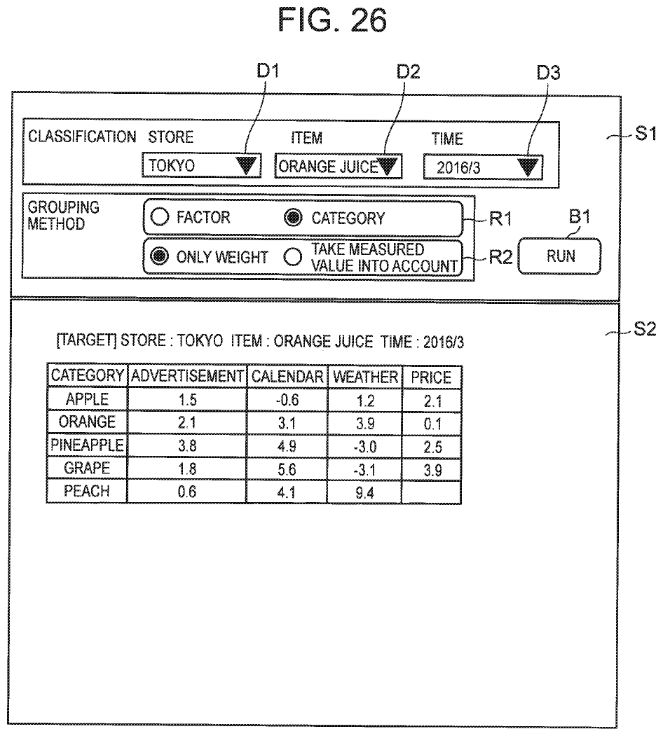

FIG. 25 illustrates an example of a result of tallying and outputting the factors of sales of orange juice at all stores in Tokyo for each category. Further, FIG. 26 illustrates an example of a result of tallying and outputting the factors of sales of all the fruit drinks at store A for each category. In the example illustrated in FIG. 23, there are 14 factors, whereas, in the example illustrated in FIG. 25, the factors are grouped into four categories. Further, in the example illustrated in FIG. 24, there are 15 factors, whereas, in the example illustrated in FIG. 26, the factors are grouped into four categories. In either case, it can be said that the interpretability becomes higher.

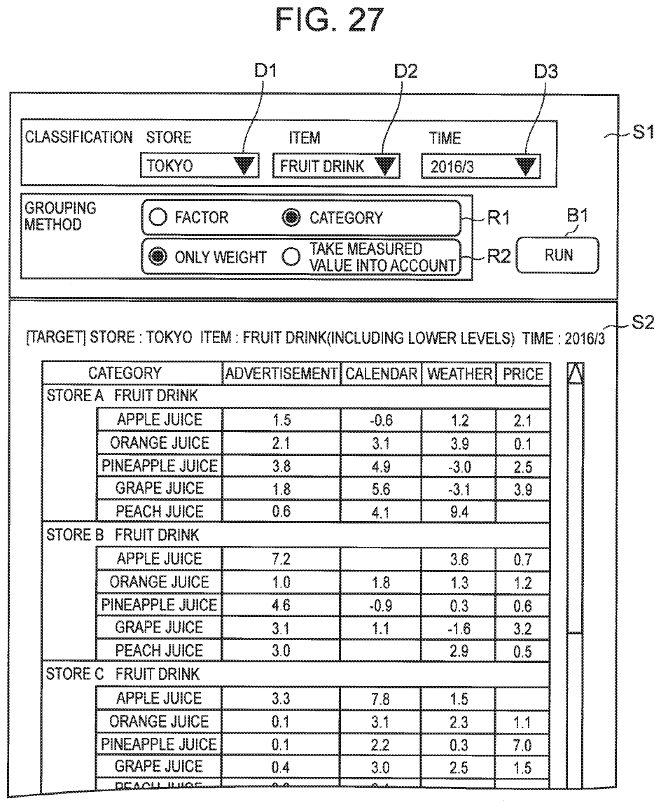

Further, FIG. 27 illustrates an example of a result of extracting apple juice, orange juice, pineapple juice, grape juice, and peach juice included in the lower-level classification of the classification of fruit drinks for analyzing the factors of sales of fruit drinks in Tokyo for each category. As illustrated in FIG. 27, when a plurality of upper-level classifications (Tokyo and fruit drinks) are designated, the display control unit may expand and display lower-level classifications of each of the upper-level classifications.

### Fourth Exemplary Embodiment

Next, a description will be given of a fourth exemplary embodiment of the information processing system according to the present invention. A configuration of the fourth exemplary embodiment is the same as the configuration of the first exemplary embodiment. However, the information processing system of the present exemplary embodiment uses a prediction model in which a linear regression equation is identified based on a value of a variable to be applied (measured value). Examples of such a prediction model in which a linear regression equation is identified based on a measured value include a case-by-case prediction model in which one linear regression equation is identified based on a sample.

First, a description will be given of the necessity to use the case-by-case prediction model. In order to use a prediction model for the purpose of factor analysis, the prediction model needs to be interpretable by humans. Examples of interpretable prediction models include a linear regression equation and a decision tree. However, in comparison to prediction models difficult to interpret (such as a neural network or a nonlinear support vector machine), the linear regression equation or the decision tree cannot capture the behavior of complex big data, resulting in lower prediction accuracy.

In order to achieve both accuracy and ease of understanding, trial and error such as that a data scientist assumes factors that change regularity, divides the data into the units, and applies a simple model such as a linear regression model to each unit of data has been widely made.

For example, assume that sales of rice balls at a convenience store are predicted. On weekdays, businesspersons make large-volume purchases, and thus it is conceivable that a display volume of items at lunchtime is highly correlated with sales. On the other hand, on holidays, many families come to the convenience store, and thus it is conceivable that differences in price from competing stores is highly correlated with sales. Accordingly, prediction can be made with high accuracy by combining explanatory variables in accordance with a simple switching rule and pattern.

However, there are an infinite number of patterns of combinations of data classifications and explanatory variables, and thus it is not realistic for a data scientist to search for a model from among the patterns one by one. The following heterogeneous mixed learning is known as a method for training a prediction model that achieves both prediction accuracy and ease of interpretation.

### REFERENCE

Ryohei Fujimaki, Satoshi Morinaga, Hiroshi Tamano, “Fully-Automatic Bayesian Piecewise Sparse Linear Models”, Proceedings of the 17th International Conference on Artificial Intelligence and Statistics (AISTATS), 2014.

In the heterogeneous mixed learning, it is possible to train a prediction model in which input data is divided into cases in accordance with a rule in a decision tree format, and prediction is made by a linear regression equation using a combination of different explanatory variables for each case. Such a prediction model is easy for humans to interpret and has high prediction accuracy. Hereinafter, such a prediction model is referred to as a case-by-case prediction model.

However, the prediction model used in the invention according to the present exemplary embodiment is not necessarily limited to the case-by-case prediction model trained by heterogeneous mixed learning. A case-by-case prediction model trained by other methods or a case-by-case prediction model created by a data scientist through trial and error can also be used in the invention according to the present exemplary embodiment.

In other words, the case-by-case prediction model includes a plurality of linear regression equations and a rule for selecting a linear regression equation to be used for prediction from the plurality of linear regression equations based on a value of a variable (hereinafter, referred to as a regression equation selection rule).

Even when a data analysis is conducted using the heterogeneous mixed learning technique described above, data is standardized in the preprocessing. Standardizing data before analysis makes it possible to appropriately compare respective degrees of influence of factors (attributes).

For example, when it is desired to predict a price of a secondhand item, examples of factors (attributes) that possibly affect the price include a year of manufacture (year), a throughput (GHz), a resolution (dot), and a color. Among these attributes, when analyzing which factors (attributes) have a large influence on the prediction result, the use of non-standardized data makes it difficult to compare the factors because the units and scales of the data are different. On the other hand, standardizing the input data causes a coefficient of a created prediction equation to be also standardized, so that the respective influences of the factors (attributes) can be compared with no consideration given to a difference in units or scales.

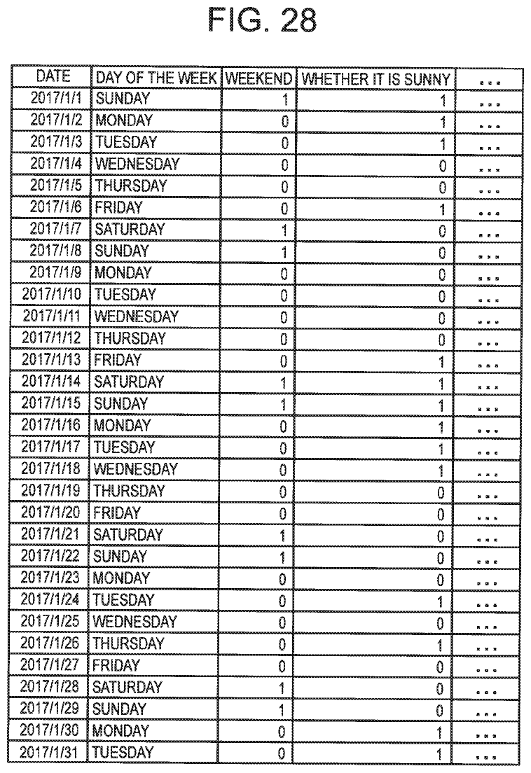

Hereinafter, a description will be given of the case-by-case prediction model described above with reference to a specific example. In the following description, it is assumed that the case-by-case prediction model serves as a prediction model used for predicting sales of orange juice at store A on a certain day in January 2017. FIG. 28 is an explanatory diagram illustrating an example of a sample. In the example illustrated in FIG. 28, as a value of an explanatory variable used in the prediction model, a value representing whether it is a weekend (1 if it is a weekend, otherwise, 0), a value representing whether it is sunny (1, if it is sunny, otherwise, 0) are identified for each day. Note that, in FIG. 28, only two explanatory variables are illustrated, but various other explanatory variables and their values are identified.

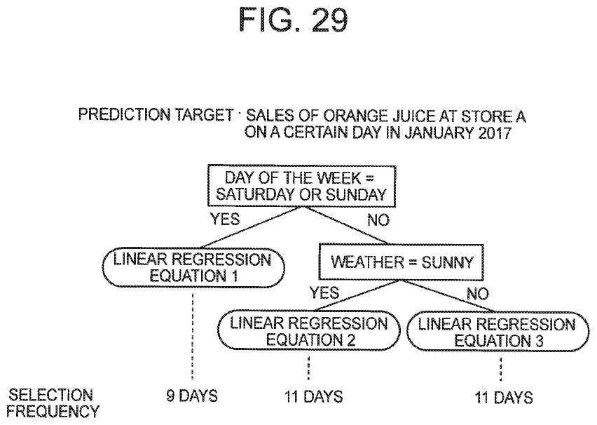

FIG. 29 is an explanatory diagram illustrating an example of the case-by-case prediction model. FIG. 29 schematically illustrates that the linear regression equation changes in accordance with the sample. FIG. 29 illustrates that the case-by-case prediction model includes three linear regression equations (linear regression equations 1 to 3), and a rule for selecting a linear regression equation to be used for prediction from among the linear regression equations 1 to 3 based on the variables representing a day of the week and weather.

Specifically, the regression equation selection rule of the case-by-case prediction model illustrated in FIG. 29 is a rule under which when it is either Saturday or Sunday, the linear regression equation 1 is selected, when it is neither Saturday nor Sunday and it is sunny, the linear regression equation 2 is selected, otherwise, the linear regression equation 3 is selected. The use of this regression equation selection rule causes a linear regression equation to be selected in accordance with the sample.

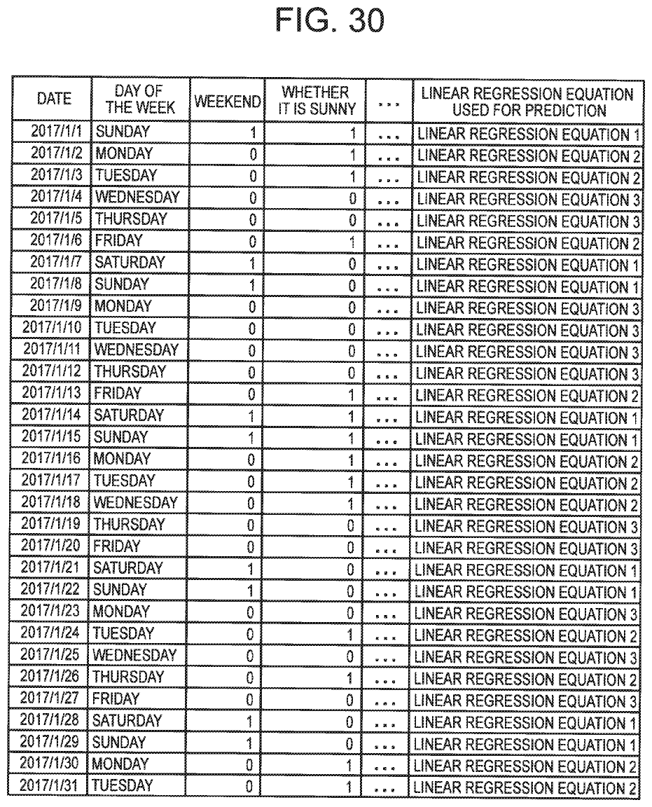

FIG. 30 is an explanatory diagram illustrating example of linear regression equations selected in the case-by-case prediction model. FIG. 30 illustrates linear regression equations selected in accordance with the sample illustrated in FIG. 28 when the case-by-case prediction model illustrated in FIG. 29 is used.

Note that selection frequency illustrated in FIG. 29 represents a ratio at which each of the linear regression equations has been selected in accordance with the sample illustrated in FIG. 28. In other words, since the linear regression equation is selected in accordance with the sample, it can be said that the ratio indicates a ratio of the number of samples for the linear regression equations.

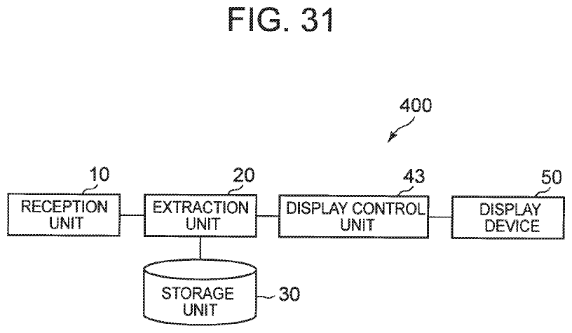

FIG. 31 is a block diagram of the information processing system according to the present invention, illustrating an example of a configuration of the fourth exemplary embodiment. An information processing system 400 of the present exemplary embodiment includes the reception unit 10, the extraction unit 20, the storage unit 30, a display control unit 43, and the display device 50. Respective operations of the reception unit 10, the extraction unit 20, the storage unit 30, and the display device 50 are the same as the operations in the first exemplary embodiment. That is, the extraction unit 20 extracts a case-by-case prediction model from the storage unit 30 based on a classification received by the reception unit 10.

The information processing system 400 of the present exemplary embodiment may further include the grouping unit 60 of the second exemplary embodiment, and the storage unit 30 may be implemented as the storage unit 31. In this case, after each linear regression equation is selected based on the sample, the grouping unit 60 may tally the weights of a plurality of variables for each corresponding category.

The information processing system 400 of the present exemplary embodiment may further include the calculation unit 61 of the third exemplary embodiment. In this case, after each linear regression equation is selected based on the sample, the calculation unit 61 may calculate the product of the coefficient in each linear regression equation and the value of the variable.

The display control unit 43 causes the display device 50 to display the extracted case-by-case prediction model. At that time, as illustrated in FIG. 29, the display control unit 43 may display each of the plurality of linear regression equations included in the case-by-case prediction model with the linear regression equation associated with the frequency or selection ratio at which the linear regression equation has been used for prediction processing.

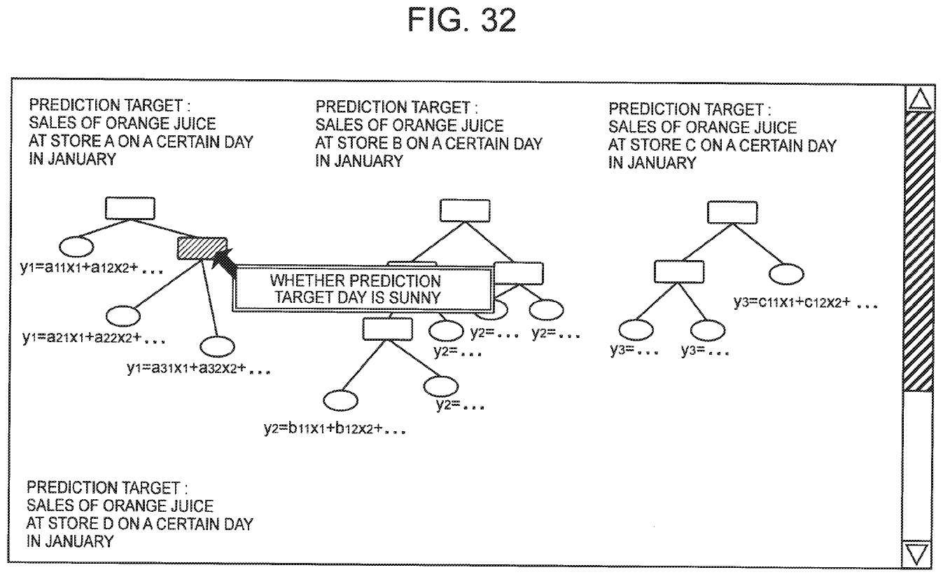

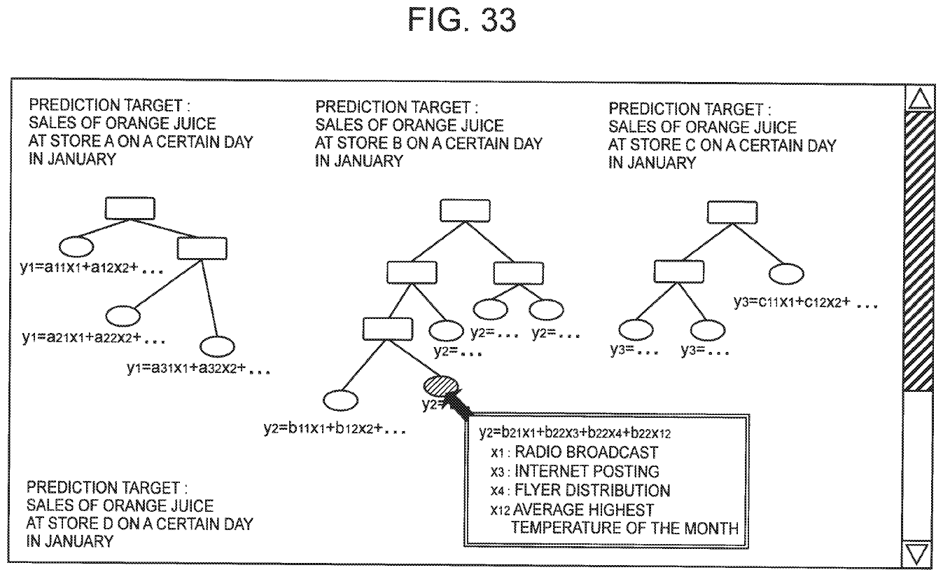

FIG. 32 and FIG. 33 are explanatory diagrams illustrating an example of how to display a case-by-case prediction model. FIG. 32 and FIG. 33 illustrate an example of a case-by-case prediction model in which the regression equation selection rule can be represented by a tree structure. In the case-by-case prediction model illustrated in FIG. 32 and FIG. 33, each node represents a conditional branch, and a leaf node represents a linear regression equation.

When the reception unit 10 receives the classifications “store A, store B, store C, and store D”, “January”, and “orange juice”, and the extraction unit 20 extracts four types of prediction models, the display control unit 43 may display each case-by-case prediction model in the manner as illustrated in FIG. 32.

Since the case-by-case prediction model includes “a regression equation selection rule” and “a plurality of linear regression equations”, it is more complicated than a simple linear regression equation. Therefore, the reception unit 10 may receive the designation of the case-by-case prediction model displayed by a pointing device such as a mouse (for example, the designation of a specific branch condition, a specific linear regression equation, or a specific variable). Then, the display control unit 43 may display a pop-up window of the details of information representing contents of the case-by-case prediction model at a location where the designation has been received.

In the example illustrated in FIG. 32, the reception unit 10 receives the designation of a location representing a branch in the case-by-case prediction model representing “sales of orange juice at store A on a certain day in January”. At this time, for example, the display control unit 43 may display a pop-up window of a branch condition of the regression equation selection rule “whether the prediction target day is sunny” indicated by the location.

In addition, as illustrated in FIG. 33, when the reception unit 10 receives the designation of a location representing a linear regression equation, the display control unit 43 may display the details the linear regression equation (for example, information on a function and an explanatory variable). Further, as described above, the display control unit 43 may also display the frequency at which each linear regression equation has been used.

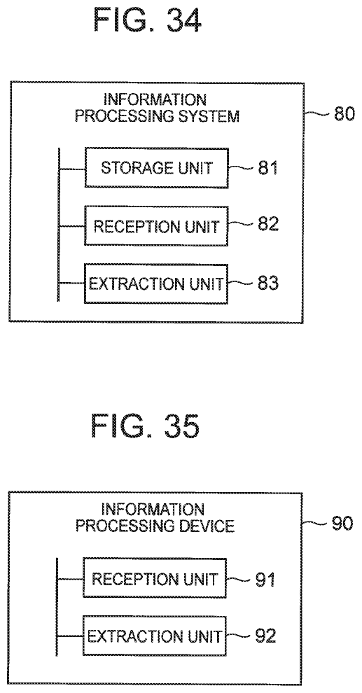

Next, a description will be given of an outline of the present invention. FIG. 34 is a block diagram schematically illustrating the information processing system according to the present invention. An information processing system 80 according to the present invention includes a storage unit 81 (for example, the storage unit 30 or 31) that stores a plurality of predictions models identified by a plurality of classifications and used for predicting a value of a prediction target, a reception unit 82 (for example, the reception unit 10) that receives at least one of the plurality of classifications, and an extraction unit 83 (for example, the extraction unit 20) that extracts a prediction model from the storage unit 81 based on the classification received by the reception unit 82.

In a case where the prediction model is used for the purpose of factor analysis, this configuration makes it possible to conduct, even when a large number of prediction models are present, the factor analysis using these prediction models with high usability.

Further, at least one of the plurality of classifications has a hierarchical structure, the reception unit 82 may receive an upper-level classification in the classification having a hierarchical structure, and the extraction unit 83 may extract a plurality of prediction models identified by lower-level classifications included in the upper-level classification from the storage unit 81 based on the upper-level classification.

Specifically, the plurality of classifications may include the classification for items or services, the classification for geographical factors, and the classification for time factors.

Specifically, the prediction target may represent how well a certain item sells at a certain store or region over the model operation span.

Specifically, the prediction model may include a plurality of variables that possibly affect the prediction target and a plurality of weights applied to the variables.

The information processing system 80 may further include a category storage unit (for example, the storage unit 31) that stores an association between a variable and a category to which the variable belongs, and a grouping unit (for example, the grouping unit 60) that groups the weights of a plurality of variables included in an extracted prediction model for each category set to the variables. Such a configuration makes it possible to conduct an analysis from broader viewpoints.

The information processing system 80 may further include a calculation unit (for example, the calculation unit 61) that calculates, for each variable included in the extracted prediction model, a product of the coefficient of the variable and the value of the variable as the weight of the variable. Such a configuration makes it possible to conduct an analysis reflecting a measured value.

The information processing system 80 may further include a display control unit (for example, the display control unit 40) that causes a display device (for example, the display device 50) to display a variable included in the extracted prediction model and the weight of the variable with the variable and the weight associated with each other.

On the other hand, the prediction model may be a case-by-case prediction model. The case-by-case prediction model may include a plurality of linear regression equations and a regression equation selection rule that defines a rule for selecting a linear regression equation to be used for prediction from the plurality of linear regression equations based on the value of a variable.

The information processing system 80 may further include a display control unit (for example, the display control unit 42) that causes a display device (for example, the display device 50) to display an extracted case-by-case prediction model. Then, the display control unit may display, for each of the plurality of linear regression equations included in the case-by-case prediction model, a frequency at which the linear regression equation has been used for prediction processing with the frequency and the linear regression equation associated with each other.

Furthermore, the reception unit 82 may receive the designation of the displayed case-by-case prediction model. Then, the display control unit may cause the display device to display information representing contents of the case-by-case prediction model at a location where the designation has been received.

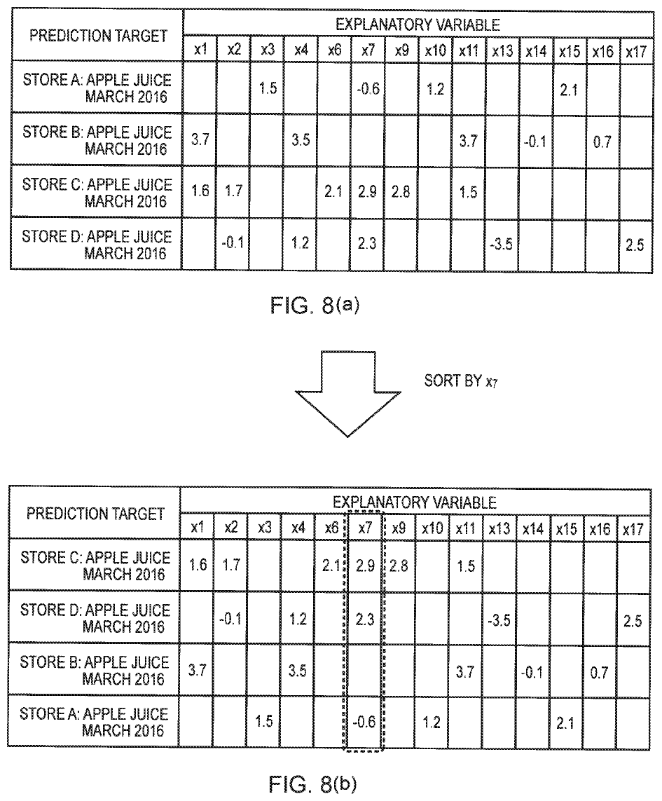

FIG. 35 is a block diagram schematically illustrating an information processing device according to the present invention. An information processing device 90 according to the present invention includes a reception unit 91 (for example, the reception unit 10) that receives at least one of a plurality of classifications, and an extraction unit 92 (for example, the extraction unit 20) that extracts, from a storage unit (for example, the storage unit 30 or 31) that stores a plurality of predictions models identified by the plurality of classifications and used for predicting a value of a prediction target, a predictions model based on the classification received by the reception unit 91.

In a case where the prediction model is used for the purpose of factor analysis, this configuration also makes it possible to conduct, even when a large number of prediction models are present, the factor analysis using these prediction models with high usability.

Some or all of the above embodiments may be described as in the following supplementary notes, but are not limited to the following.

(Supplementary note 1) An information processing system includes, a storage unit which stores a plurality of prediction models that are each identified by a plurality of classifications and used for predicting a value of a prediction target, a reception unit which receives at least one of the plurality of classifications, and an extraction unit which extracts a prediction model from the storage unit based on the classification received by the reception unit.

(Supplementary note 2) In the information processing system according to Supplementary note 1, at least one of the plurality of classifications has a hierarchical structure, the reception unit receives an upper-level classification in the classification having a hierarchical structure, and the extraction unit extracts, from the storage unit, a plurality of prediction models identified by lower-level classifications included in the upper-level classification based on the upper-level classification.

(Supplementary note 3) In the information processing system according to Supplementary note 1 or 2, the plurality of classifications includes a classification for items or services, a classification for geographic factors, and a classification for time factors.

(Supplementary note 4) In the information processing system according to any one of Supplementary notes 1 to 3, the prediction target represents how well a certain item sells at a certain store or region over a model operation span.

(Supplementary note 5) In the information processing system according to any one of Supplementary notes 1 to 4, each of the prediction models includes a plurality of variables that each possibly affect the prediction target and a plurality of weights applied to the variables.

(Supplementary note 6) The information processing system according to any one of Supplementary notes 1 to 5, further includes a category storage unit which stores an association between a variable and a category to which the variable belongs, and a grouping unit which groups weights of a plurality of variables included in the extracted prediction model for each category to which the variables belong.

(Supplementary note 7) The information processing system according to any one of Supplementary notes 1 to 6, further includes a calculation unit which calculates, for each variable included in the extracted prediction model, a product of a coefficient of the variable and a value of the variable as a weight of the variable.

(Supplementary note 8) The information processing system according to any one of Supplementary notes 1 to 7, further includes a display control unit which causes a display device to display a variable and a weight of the variable included in the extracted prediction model with the variable and the weight of the variable associated with each other.

(Supplementary note 9) In the information processing system according to any one of Supplementary notes 1 to 8, each of the prediction models is a case-by-case prediction model, the case-by-case prediction model includes a plurality of linear regression equations and a regression equation selection rule that defines a rule for selecting a linear regression equation to be used for prediction from the plurality of linear regression equations based on a value of a variable.

(Supplementary note 10) The information processing system according to Supplementary note 9, further includes a display control unit which causes a display device to display an extracted case-by-case prediction model, and the display control unit displays, for each of the plurality of linear regression equations included in the case-by-case prediction model, a frequency at which the linear regression equation has been used in prediction processing with the frequency and the linear regression equation associated with each other.

(Supplementary note 11) The information processing system according to Supplementary note 9 or 10, further includes a display control unit which causes a display device to display an extracted case-by-case prediction model, the reception unit receives designation of the case-by-case prediction model thus displayed, and the display control unit causes the display device to display information representing details of the case-by-case prediction model in accordance with a location where the designation is received.

(Supplementary note 12) An information processing device includes a reception unit which receives at least one of a plurality of classifications, and an extraction unit which extracts, from a storage unit that stores a plurality of prediction models that are each identified by the plurality of classifications and used for predicting a value of a prediction target, the prediction model based on the classification received by the reception unit.

(Supplementary note 13) A prediction model extraction method includes receiving at least one of a plurality of classifications, and extracting, from a storage unit that stores a plurality of prediction models that are each identified by the plurality of classifications and used for predicting a value of a prediction target, the prediction model based on the classification thus received.

(Supplementary note 14) A prediction model extraction program causes a computer to execute reception processing of receiving at least one of a plurality of classifications, and extraction processing of extracting, from a storage unit that stores a plurality of prediction models that are each identified by the plurality of classifications and used for predicting a value of a prediction target, the prediction model based on the classification received in the reception processing.

### REFERENCE SIGNS LIST

10 Reception unit
20 Extraction unit
30 Storage unit
40, 41 Display control unit
50 Display device
60 Grouping unit
61 Calculation unit
100, 200, 300, 400 Information processing system

1. An information processing system comprising:
a hardware including a processor;
a storage unit which stores a plurality of prediction models that are each identified by a plurality of classifications and used for predicting a value of a prediction target;
a reception unit, implemented by the processor, which receives at least one of the plurality of classifications; and
an extraction unit, implemented by the processor, which extracts a prediction model from the storage unit based on the classification received by the reception unit.

2. The information processing system according to claim 1, wherein
at least one of the plurality of classifications has a hierarchical structure,
the reception unit receives an upper-level classification in the classification having the hierarchical structure, and
the extraction unit extracts, from the storage unit, a plurality of prediction models identified by lower-level classifications included in the upper-level classification based on the upper-level classification.

3. The information processing system according to claim 1, wherein
the plurality of classifications includes a classification for items or services, a classification for geographic factors, and a classification for time factors.

4. The information processing system according to claim 1, wherein
the prediction target represents how well a certain item sells at a certain store or region over a model operation span.

5. The information processing system according to claim 1, wherein
each of the prediction models includes a plurality of variables that each possibly affect the prediction target and a plurality of weights applied to the variables.

6. The information processing system according to claim 1, further comprising:
a category storage unit which stores an association between a variable and a category to which the variable belongs; and
a grouping unit, implemented by the processor, which groups weights of a plurality of variables included in the extracted prediction model for each category to which the variables belong.

7. The information processing system according to claim 1, further comprising a calculation unit, implemented by the processor, which calculates, for each variable included in the extracted prediction model, a product of a coefficient of the variable and a value of the variable as a weight of the variable.

8. The information processing system according to claim 1, further comprising a display control unit, implemented by the processor, which causes a display device to display a variable and a weight of the variable included in the extracted prediction model with the variable and the weight of the variable associated with each other.

9. The information processing system according to claim 1, wherein
each of the prediction models is a case-by-case prediction model,
the case-by-case prediction model includes a plurality of linear regression equations and a regression equation selection rule that defines a rule for selecting a linear regression equation to be used for prediction from the plurality of linear regression equations based on a value of a variable.

10. The information processing system according to claim 9, further comprising a display control unit, implemented by the processor, which causes a display device to display an extracted case-by-case prediction model, wherein
the display control unit displays, for each of the plurality of linear regression equations included in the case-by-case prediction model, a frequency at which the linear regression equation has been used in prediction processing with the frequency and the linear regression equation associated with each other.

11. The information processing system according to claim 9, further comprising a display control unit, implemented by the processor, which causes a display device to display an extracted case-by-case prediction model, wherein
the reception unit receives designation of the case-by-case prediction model thus displayed, and
the display control unit causes the display device to display information representing details of the case-by-case prediction model in accordance with a location where the designation is received.

12. An information processing device comprising:
a hardware including a processor;
a reception unit, implemented by the processor, which receives at least one of a plurality of classifications; and
an extraction unit, implemented by the processor, which extracts, from a storage unit that stores a plurality of prediction models that are each identified by the plurality of classifications and used for predicting a value of a prediction target, the prediction model based on the classification received by the reception unit.

13. A prediction model extraction method comprising:
receiving at least one of a plurality of classifications; and
extracting, from a storage unit that stores a plurality of prediction models that are each identified by the plurality of classifications and used for predicting a value of a prediction target, the prediction model based on the classification thus received.

14. (canceled)
